(19) United States
(12) Patent Application Publication
(10) Pub. No.: US 2026/0037665 A1
(43) Pub. Date: Feb. 5, 2026

(54) AGGREGATION CONSTRAINTS IN A QUERY PROCESSING SYSTEM

(71) Applicant: Snowflake Inc., Bozeman, MT (US)

(72) Inventors: Khalid Zaman Bijon, Santa Cruz, CA (US); Bowei Chen, San Bruno, CA (US); Thierry Cruanes, San Mateo, CA (US); Simon Holm Jensen, Menlo Park, CA (US); Allison Waingold Lee, Pebble Beach, CA (US); Valentin K. Kuznetsov, Bellevue, WA (US); Jun Li, Bothell, WA (US); Subramanian Muralidhar, Mercer Island, WA (US); Carl Yates Perry, Burlingame, CA (US); David Schultz, Piedmont, CA (US); Zixi Zhang, San Mateo, CA (US)

(21) Appl. No.: 19/350,894

(22) Filed: Oct. 6, 2025

Related U.S. Application Data
(63) Continuation of application No. 18/345,971, filed on Jun. 30, 2023.
(60) Provisional application No. 63/488,730, filed on Mar. 6, 2023.

(51) Int. Cl. G06F 21/62; G06F 16/242

(52) U.S. Cl. CPC G06F 21/6245; G06F 16/244; G06F 2221/2113

(57) ABSTRACT

A system is disclosed that includes one or more hardware processors and at least one memory storing instructions. The system receives a first query directed towards a shared dataset and accesses a first set of data from a first table in the shared dataset. The system determines that an aggregation constraint policy is attached to the first table, which restricts output of data values stored in the table. The system performs a uniqueness check on join keys for a join operation associated with the first table, verifying that at least one row from the first table is not amplified in the result. The system enforces the aggregation constraint policy on the first query based on this verification. The system generates an output to the first query based on the first set of data. This approach helps control data aggregation and ensures privacy when accessing shared datasets.

### CROSS-REFERENCE TO RELATED APPLICATIONS

The present application is a Continuation of U.S. patent application Ser. No. 18/345,971, filed Jun. 30, 2023, entitled, “Aggregation Constraints in a Query Processing System,” which claims benefit of earlier filing date and right of priority to U.S. Provisional Patent Application Ser. No. 63/488,730, filed on Mar. 6, 2023, entitled, “Aggregation-Constraints in a Query Processing System,” all of the contents of which are hereby incorporated by reference herein in their entireties.

### TECHNICAL FIELD

The present disclosure generally relates to special-purpose machines that manage data platforms and databases and, more specifically, to data platforms that provide aggregation constraints in a query processing system.

### BACKGROUND

Cloud data platforms may be provided through a cloud data platform, which allows organizations, customers, and users to store, manage, and retrieve data from the cloud. With respect to type of data processing, a cloud data platform could implement online transactional processing, online analytical processing, a combination of the two, and/or other types of data processing. Moreover, a cloud data platform could be or include a relational database management system and/or one or more other types of database management systems.

Databases are used for data storage and access in computing applications. A goal of database storage is to provide enormous sums of information in an organized manner so that it can be accessed, managed, and updated. In a database, data may be organized into rows, columns, and tables. A database platform can have different databases managed by different users. The users may seek to share their database data with one another; however, it is difficult to share the database data in a secure and scalable manner.

### BRIEF DESCRIPTION OF THE DRAWINGS

Various ones of the appended drawings merely illustrate example embodiments of the present disclosure and should not be considered as limiting its scope.

FIG. 1 illustrates an example computing environment in which a cloud data platform can implement aggregation constraints, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a block diagram illustrating components of an aggregation system, according to some example embodiments.

FIG. 5 illustrates an example two-party data sharing scenario in which aggregation constraints can be implemented, according to some example embodiments.

FIG. 6 illustrates an example two-party scenario for combining sensitive data in which aggregation constraints can be implemented, according to some example embodiments.

FIG. 7 illustrates an example data sharing scenario in which aggregation constraints can be implemented, according to some example embodiments.

FIG. 8 illustrates an example data sharing scenario in which a provider shares data with internal users by implementing aggregation constraints, according to some example embodiments.

FIG. 9 illustrates an example block diagram providing multiple data steward scenarios, according to some example embodiments.

FIG. 10 is an illustration of an example aggregation policy specifying allowed aggregate functions, according to some example embodiments.

FIG. 11 is an example class chart of allowed aggregation functions, according to some example embodiments.

FIG. 12 illustrates an example chart displaying aggregation constraint data usage in a request processing system, according to some example embodiments.

FIG. 13 is a block diagram illustrating aggregation constraint group size, according to some example embodiments.

FIG. 14 is an illustration of multiple example customer data charts for combining projection and aggregation constraints, according to some example embodiments.

FIG. 15 illustrates an example Unified Modeling Language (UML) diagram for implementing aggregation constraint-based access to a dataset on a distributed database, according to some example embodiments.

FIG. 16 illustrates an example UML diagram for representing different aspects of an implementation of an aggregation constraint system, according to some example embodiments.

FIG. 17 illustrates an example flow diagram of a method for performing a uniqueness check in an aggregation constraint system, according to some example embodiments.

FIG. 18 illustrates an example flow diagram of a method for implementing executing an aggregate function in a constrained aggregation query block, according to some example embodiments.

FIG. 19 illustrates an example flow diagram of a method for using an aggregation constraint-based system for a query with nontrivial grouping sets, according to some example embodiments.

FIG. 20 illustrates an example flow diagram of a method for implementing aggregation constraint-based access to a dataset on a distributed database, according to some example embodiments.

FIG. 21 shows an example of database restrictions on access to database data, according to some example embodiments.

FIG. 22 shows example sets of source data from different database accounts, according to some example embodiments.

FIG. 23 shows an example database architecture for implementing query templates for multiple entities sharing data in a data clean environment, according to some example embodiments.

FIG. 24 shows an example database architecture for implementing query templates for multiple entities sharing data in a data clean environment, according to some example embodiments.

FIG. 25 shows an example database architecture for implementing query templates for multiple entities sharing data in a data clean environment, according to some example embodiments.

FIG. 26 shows an example database architecture for implementing a defined access clean room, according to some example embodiments.

FIG. 27 shows an example database architecture for implementing a defined access clean room, according to some example embodiments.

FIG. 28 illustrates an example diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

Databases are used by various entities (e.g., businesses, people, organizations, etc.) to store data. For example, a retailer may store data describing purchases (e.g., product, date, price, etc.) and the purchasers (e.g., name, address, email address, etc.). Similarly, an advertiser may store data describing performance of their advertising campaigns, such as the advertisements served to users, date that advertisement was served, information about the user, (e.g., name, address, email address), and the like. In some cases, entities may wish to share their data with each other. For example, a retailer and advertiser may wish to share their data to determine the effectiveness of an advertisement campaign, such as by determining a fraction of users who saw the advertisement and subsequently purchased the product (e.g., determining a conversion rate of users that were served advertisements for a product and ultimately purchased the product). In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like.

Traditional approaches address this problem through prior solutions including heuristic anonymization techniques or differential privacy. For example, heuristic anonymization techniques (e.g., k-anonymity, l-diversity, and t-closeness) transform a dataset to remove identifying attributes from data. The anonymized data may then be freely analyzed, with limited risk that the analyst can determine the individual that any given row in a database (e.g., table) corresponds to. Differential privacy (DP) is a rigorous definition of what it means for query results to protect individual privacy. A typical solution that satisfies DP requires an analyst to perform an aggregate query and then adds random noise drawn from a Laplace or Gaussian distribution to the query result. Additional existing solutions include tokenization, which can only support exact matches of quality joins and often fails to protect privacy due to identity inference by other attributes.

Existing methods fail to overcome the technical challenges related to maintaining the confidentiality of personal identifying information while data sharing across organizations for multiple reasons. For example, heuristic anonymization techniques can allow for data values in individual rows of a database to be seen, which increases a privacy risk; such techniques also require the removal or suppression of identifying and quasi-identifying attributes. This makes heuristic techniques like k-anonymity inappropriate for data sharing and collaboration scenarios, where identifying attributes are often needed to join datasets across entities (e.g., advertising, researching, etc.). Existing differential privacy methods fail to overcome the technical challenges; for example, DP requires a user to specify privacy budget parameters (e.g., epsilon, delta, kappa), requires a user to specify non-sensitive columns that are permitted to be used as grouping keys, and requires the addition of Laplace noise to query results. Further existing methods may not be accurate causing usability issues and fail to provide grouping mechanisms such as example embodiments of the present disclosure detailed throughout.

Example embodiments of the present disclosure are directed to systems, methods, and machine-readable mediums that include aggregation constraints to allow customers, such as data providers (e.g., data steward, data owner, etc.), of a cloud data platform, to specify restrictions on how their data can be used in order to protect sensitive data (e.g., PII, data desired to be maintained as private, etc.) from misuse. As used herein, a provider is an organization, company, or account that owns and hosts a database or a set of data within the cloud data platform, the provider can be responsible for making the data available to other accounts or consumers for sharing and analysis such as sharing specific databases, schemas, relations, or the like with other accounts. To resolve existing technical problems, example embodiments of a cloud data platform can employ an aggregation system to enforce aggregation constraints on data values stored in specified tables of a shared dataset when requests (e.g., queries) are received in the cloud data platform. Example embodiments of the present disclosure include an aggregation system, where an aggregation constraint on a table is a constraint that is used to specify or indicate sensitive data to be shared while allowing limitations on what data and/or how the data can be used. An aggregation constraint ensures that all queries over a constrained table or view (or other schema) can only report data from that table in aggregated form.

As used herein, aggregation constraints, such as aggregation constraint policies, can comprise (or refer to) a policy, rule, guideline, or combination thereof or, rule for limiting, for example, the ways that data can be aggregated or restricting to only aggregate data in specific ways according to a data provider's determinations (e.g., policies). For example, aggregation constraints enable use of providing restrictions, limitations, or other forms of data provider control over the aggregated data for purposes of queries and return responses to queries.

An aggregation constraint can include criteria or dimension on what data in a shared dataset can be grouped together based on defined or provided operations (e.g., functions) applied to the data in each group. Aggregation constraints enable customers and users to analyze, share, collaborate, and combine datasets containing sensitive information while mitigating risks of exposing the sensitive information, where aggregation can include the grouping and/or combining of data to obtain summary information (e.g., minimum, totals, counts, averages, etc.). An aggregation constraint can identify that the data in a table should be restricted from being aggregated using functions such as AVG, COUNT, MIN, MAX, SUM, and the like to calculate aggregated values based on groups of data. For example, the inputs do not skew or amplify specific values in a way that might create privacy challenges), and they do not reveal specific values in the input.

In some example embodiments, aggregation constraints can be implemented in data clean rooms (e.g., defined-access clean rooms) to enable data providers to specify, in some examples via the provider's own code, what queries consumers can run on the data. As used herein, a consumer is an organization, company, or account that accesses and consumes data shared by the provider, where consumers can access and query the shared data without the need for data replication or data movement. Consumers can further combine the shared data with their own data within the cloud data platform to perform various analytical operations on the data. Providers can offer flexibility via parameters and query templates, and the provider can control the vocabulary of the questions that can be asked. The aggregation constraints can further be implemented as a type of query constraint that allow data providers to specify general restrictions on how the data can be used. The consumer can formulate the queries, and the platform (e.g., cloud data platform, database platform, on-premises platform, trusted data processing platform, and the like) ensures that these queries abide by the provider's aggregation constraint requirements.

Example embodiments of the present disclosure improve upon existing techniques and overcome current technical challenges by providing a system of aggregation constraints to analyze, share, collaborate, and combine datasets containing sensitive information, including PII, while mitigating the risks of exposing the sensitive information directly. To alleviate these issues, a cloud data platform can utilize an aggregation constraint system (also referred to as an “aggregation system”) that opts to enforce aggregation constraints on data values stored in specified tables of a shared dataset when queries are received by the cloud data platform.

Thus, example embodiments of the present disclosure solve the technical problem relating to entities (e.g., data providers, data consumers, combination users, etc.) specifying restrictions on how their data can be used by enabling a system of aggregation constraints (e.g., constraints on queries) to protect sensitive data from misuse and reduce privacy risks. Query constraints enable entities to specify general restrictions on how the data can be used. For example, a data consumer can formulate a query and the cloud data platform, according to example embodiments, can ensure that the consumer's queries abide by the provider's requirements. Enforcing aggregation constraints on queries, received at the cloud data platform, allows for data to be shared and used by entities to extract insights, while blocking queries that target individual rows.

One benefit of aggregation constraints as described herein is the aggregation constraints allow a user (e.g., an analyst) to join datasets on a sensitive key (e.g., an email address) without revealing the email address itself. While tokenization may allow a user to duplicate this result, it does so by obscuring the email address, which is different from the approach set forth in this disclosure and tokenization has inferior privacy protections. In addition to other improvements, the difficulty and computing resources required for tokenization is eliminated, and additional functionality and operations (e.g., fuzzy matching) can be performed while maintaining the confidentiality of specified data values.

Example embodiments include technical solutions over prior data sharing by providing aggregation constraints to entities to mitigate the risks of sensitive data exposure, where the aggregation constraints achieve this by requiring that queries executed (e.g., run) against a dataset must report only aggregate statistics that cover, for example, at least a threshold number of rows in each dataset. For example, aggregation constraints restrict individual rows of a database table from being seen in order to reduce the privacy risk. Further, aggregation constraints do not require the removal or suppression of identifying or quasi-identifying attributes (e.g., email, age, zip code, etc.); as such, aggregation-constrained data can be joined with other datasets using such identifiers in order to enable data sharing and collaboration without disclosure of privacy information. Additional example embodiments enhance privacy protection by further restricting allowed queries (e.g., by enforcing a specific minimum group size for each aggregate group, and/or by limiting the allowed set of aggregate operators).

Additional example embodiments of the methods described herein can be applied to a variety of use cases. For example, methods of employing aggregation constraints in a query processing system can include audience insights and customer overlap as a way of identifying joint customers without sharing full customer lists. In other examples, methods of employing aggregation constraints in a query processing system can include advertisement activation by combining sales data with viewership and demographics data in order to determine target advertising audiences. In other examples, methods of employing aggregation constraints in a query processing system can include advertisement measurements including the reach, frequency measurements, and optimization of advertisements to learn about, for example, customer conversion rates based on impression data and sales data. In other examples, lookalike analysis for audience supplementation can be determined. In addition, machine learning algorithms and general artificial intelligence can be used to identify similar customers based on customer attributes, such as customer loyalty, purchase data, or combinations of the like.

More specifically, example embodiments disclose an aggregation system that can provide aggregation constraints to mitigate against analysts inferring anything about the values of sensitive attributes in individual rows of the table. Aggregation constraints are applied to tables, typically tables that contain sensitive attributes about individuals. Aggregation constraints ensure that values derived from these tables can only be returned in aggregates representing some minimum number of rows from the table. Aggregation constraints can be used alone or in combination with clean room systems, along with additional query constraints, such as projection constraints, to enable data sharing and collaboration while allowing data providers to set limits on how the provider's data can be used. Example embodiments provide for collaboration between multiple companies through aggregation constraints to help protect companies' sensitive data when they share and collaborate.

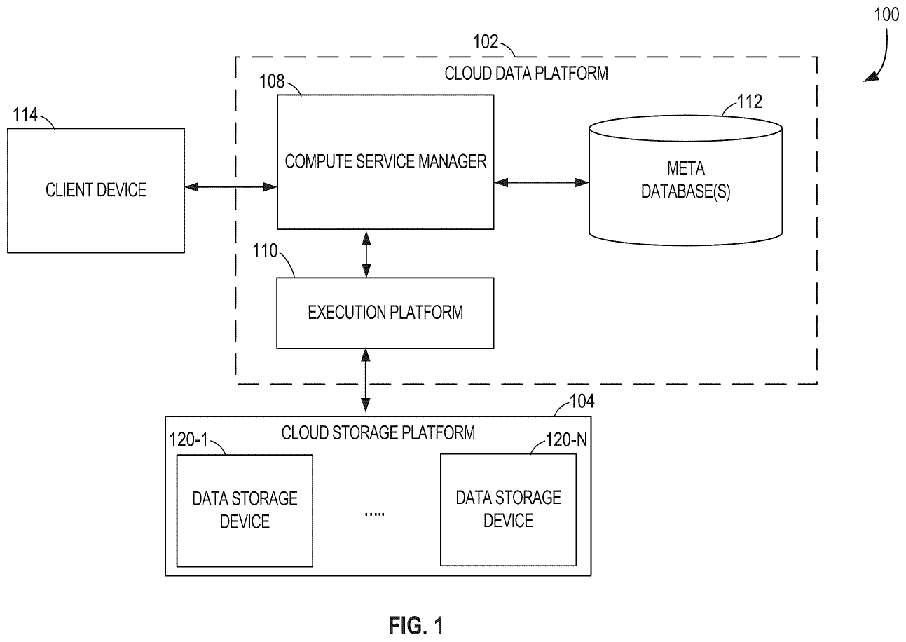

FIG. 1 illustrates an example computing environment 100 in which a cloud data platform 102 can implement aggregation constraints, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform.

As shown, the computing environment 100 comprises the cloud data platform 102 in communication with a cloud storage platform 104 (e.g., AWS®, Microsoft Azure Blob Storage®, or Google Cloud Storage). The cloud data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the cloud data platform 102. A user may utilize the client device 114 to submit data storage, retrieval, and analysis requests to the compute service manager 108.

The compute service manager 108 is also coupled to one or more metadata databases 112 that store metadata pertaining to various functions and aspects associated with the cloud data platform 102 and its users. For example, metadata database(s) 112 may include a summary of data stored in remote data storage systems as well as data available from a local cache. Additionally, metadata database(s) 112 may include information regarding how data is partitioned and organized in remote data storage systems (e.g., the cloud storage platform 104) and local caches. As discussed herein, a “micro-partition” is a batch storage unit, and each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. This granular selection process for micro-partitions to be scanned is referred to herein as “pruning.” Pruning involves using metadata to determine which portions of a table, including which micro-partitions or micro-partition groupings in the table, are not pertinent to a query, avoiding those non-pertinent micro-partitions when responding to the query, and scanning only the pertinent micro-partitions to respond to the query. Metadata may be automatically gathered on all rows stored in a micro-partition, including the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded. However, it should be appreciated that this disclosure of the micro-partition is exemplary only and should be considered non-limiting. It should be appreciated that the micro-partition may include other database storage devices without departing from the scope of the disclosure. Information stored by a metadata database 112 (e.g., key-value pair data store) allows systems and services to determine whether apiece of data (e.g., a given partition) needs to be accessed without loading or accessing the actual data from a storage device.

The compute service manager 108 is further coupled to the execution platform 110, which provides multiple computing resources that execute various data storage and data retrieval tasks. The execution platform 110 is coupled to cloud storage platform 104. The cloud storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, metadata database(s) 112, execution platform 110, and cloud storage platform 104 are shown in FIG. 1 as individual discrete components. However, each of the compute service managers 108, metadata databases 112, execution platforms 110, and cloud storage platforms 104 may be implemented as a distributed system (e.g., distributed across multiple systems/platforms at multiple geographic locations). Additionally, each of the compute service managers 108, metadata databases 112, execution platforms 110, and cloud storage platforms 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the computing environment 100 separates the execution platform 110 from the cloud storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

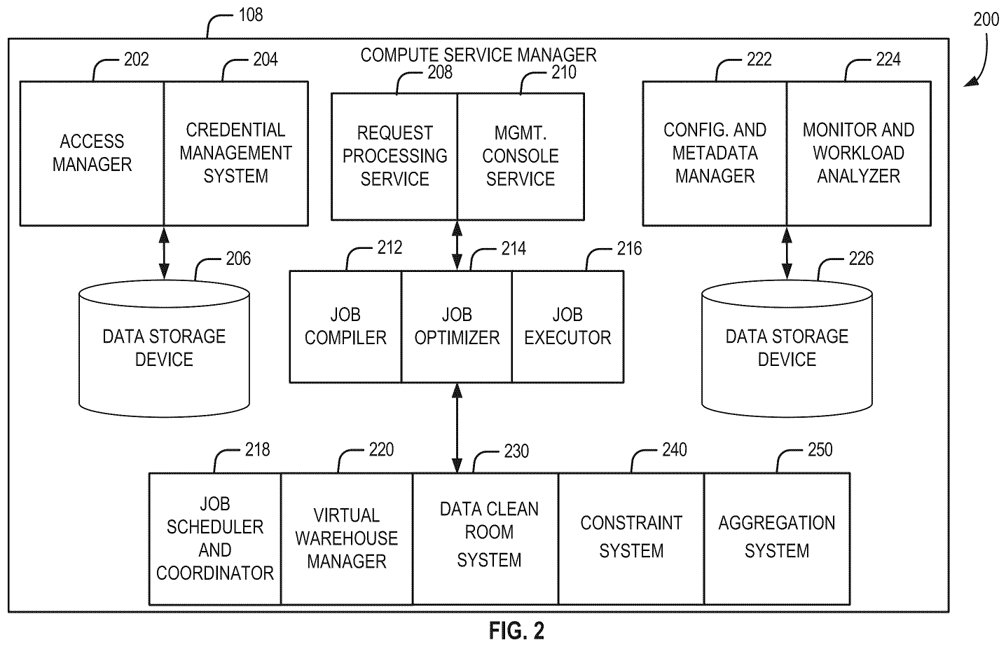

FIG. 2 is a block diagram 200 illustrating components of the compute service manager 108, in accordance with some embodiments of the present disclosure. As shown in FIG. 2, the compute service manager 108 includes an access manager 202 and a credential management system 204 coupled to data storage device 206, which is an example of the metadata databases 112. Access manager 202 handles authentication and authorization tasks for the systems described herein.

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

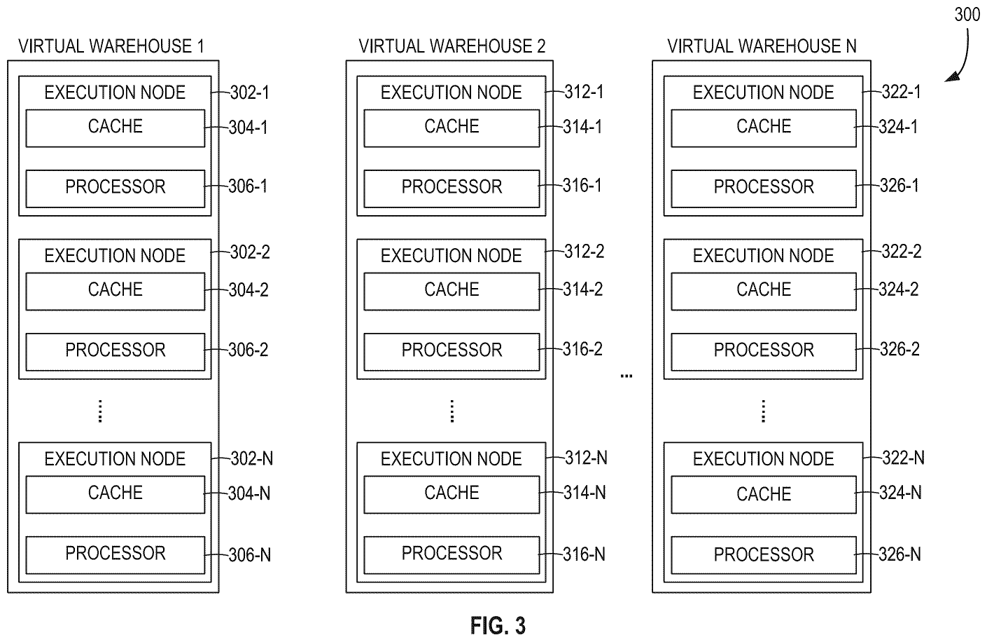

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

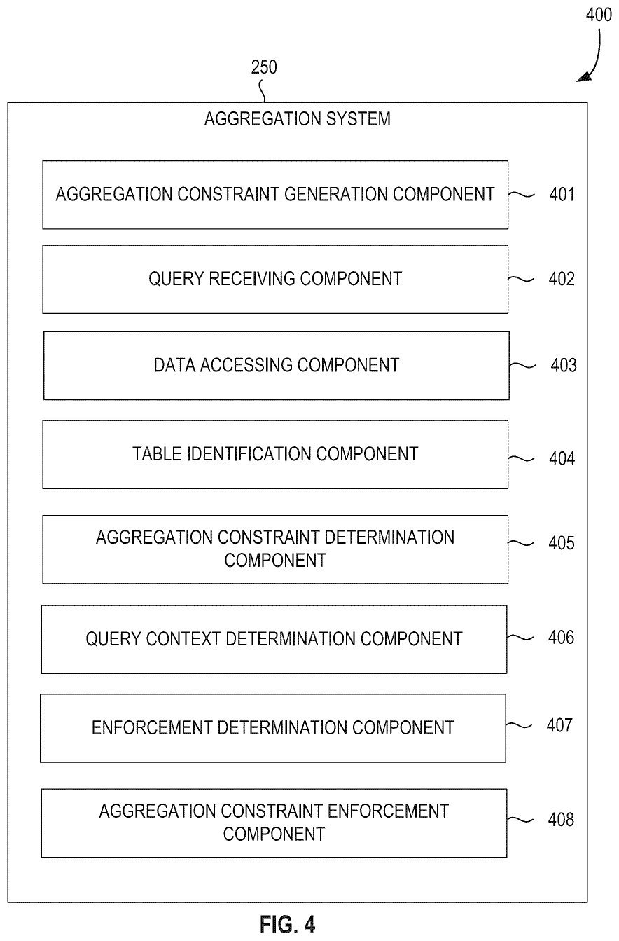

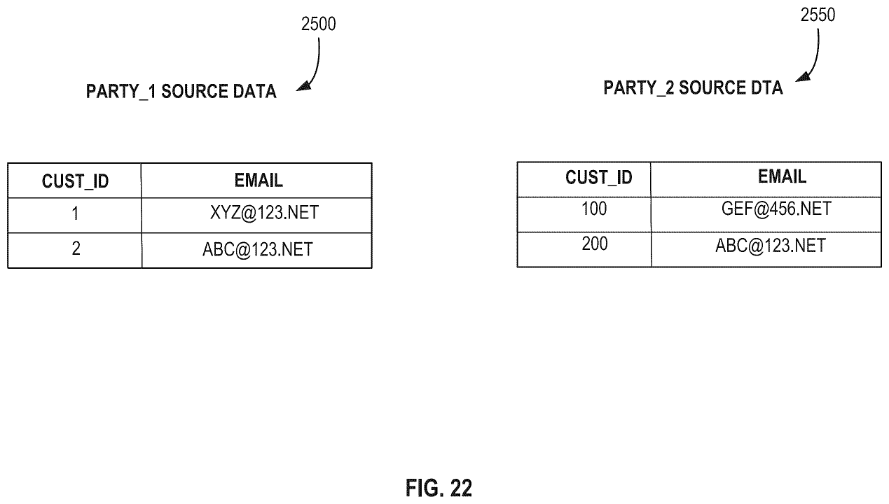

The data clean room system 230 allows for dynamically restricted data access to shared datasets, as depicted and described in further detail below with in connection with FIGS. 22-28. The constraint system 240 provides for projection constraints on data values stored in specified columns of shared datasets, as discussed in further detail below. An aggregation system 250 can be implemented within the cloud data platform 102 when processing queries directed to tables in shared datasets. The aggregation system 250 (also referred to as the aggregation constraint system) is described in detail in connection with FIG. 4. For example, in some embodiments, the aggregation system 250 can be implemented within a clean room provided by the data clean room system 230 and/or in conjunction with the constraint system 240.

The constraint system 240 enables entities to establish projection constraints (e.g., projection constraint policies) to shared datasets. A projection constraint identifies that the data in a column may be restricted from being projected (e.g., presented, read, outputted) in an output to a received query, while allowing specified operations to be performed on the data and a corresponding output to be provided. For example, the projection constraint may indicate a context for a query that triggers the constraint, such as based on the user that submitted the query.

For example, the constraint system 240 may provide a user interface or other means of communication that allows entities to define projection constraints in relation to their data that is maintained and managed by the cloud data platform 102. To define a projection constraint, the constraint system 240 enables users to provide data defining the shared datasets and columns to which a projection constraint should be associated (e.g., attached). For example, a user may submit data defining a specific column and/or a group of columns within a shared dataset that should be attached with the projection constraint.

Further, the constraint system 240 enables users to define conditions for triggering the projection constraint. This may include defining the specific context and/or contexts that triggers enforcement of the projection constraint. For example, the constraint system 240 may enable users to define roles of users, accounts and/or shares, which would trigger the projection constraint and/or are enabled to project the constrained column of data. After receiving data defining a projection constraint, the constraint system 240 generates a file that is attached to the identified columns. In some embodiments, the file may include a Boolean function based on the provided conditions for the projection constraint. For example, the Boolean function may provide an output of true if the projection constraint should be enforced in relation to a query and an output of false if the projection constraint should not be enforced in relation to a query. Attaching the file to the column establishes the projection constraint to the column of data for subsequent queries.

The constraint system 240 receives a query directed to a shared dataset. The query may include data defining data to be accessed and one or more operations to perform on the data. The operations may include any type of operations used in relation to data maintained by the cloud data platform 102, such as join operation, read operation, and the like. The constraint system 240 may provide data associated with the query to the other components of the constraint system 240, such as a data accessing component, a query context determination component, or other components of the constraint system 240. The constraint system 240 accesses a set of data based on a query received by the constraint system 240 or a component thereof. For example, the data accessing component may access data from columns and/or sub-columns of the shared dataset that are identified by the query and/or are needed to generate an output based on the received query. The constraint system 240 may provide the accessed data to other components of the constraint system 240, such as a projection constraint enforcement component. The constraint system 240 determines the columns associated with the data accessed by the constraint system 240 in response to a query. This can include columns and/or sub-columns from which the data was accessed. The constraint system 240 may provide data identifying the columns to the other components of the constraint system 240, such as a projection constraint determination component.

The constraint system 240 determines whether a projection constraint (e.g., projection constraint policy) is attached to any of the columns identified by the constraint system 240. For example, the constraint system 240 determines whether a file defining a projection constraint is attached to any of the columns and/or sub-columns identified by the constraint system 240. The constraint system 240 may provide data indicating whether a projection constraint is attached to any of the columns and/or the file defining the projection constraints to the other components of the constraint system 240, such as an enforcement determination component.

The constraint system 240 determines a context associated with a received query. For example, the constraint system 240 may use data associated with a received query to determine the context, such as by determining the role of the user that submitted the query, an account of the cloud data platform 102 associated with the submitted query, a data share associated with the query, and the like. The constraint system 240 may provide data defining the determined context of the query to the other components of the constraint system 240, such as an enforcement determination component.

The constraint system 240 determines whether a projection constraint should be enforced in relation to a received query. For example, the constraint system 240 uses the data received that indicates whether a projection constraint is attached to any of the columns and/or the file defining the projection constraints as well as the context of the query received from the constraint system 240 to determine whether a projection constraint should be enforced. If a query constraint is not attached to any of the columns, the constraint system 240 determines that a projection constraint should not be enforced in relation to the query. Alternatively, if a projection constraint is attached to one of the columns, the constraint system 240 uses the context of the query to determine whether the projection constraint should be enforced. For example, the constraint system 240 may use the context of the query to determine whether the conditions defined in the file attached to the column are satisfied to trigger the projection constraint. In some embodiments, the constraint system 240 may use the context of the query as an input into the Boolean function defined by the projection constraint to determine whether the projection constraint is triggered. For example, if the Boolean function returns a true value, the constraint system 240 determines that the projection constraint should be enforced. Alternatively, if the Boolean function returns a false value, the constraint system 240 determines that the projection constraint should not be enforced. The constraint system 240 may provide data indicating whether the projection constraint should be enforced to the other components of the constraint system 240, such as a projection constraint enforcement component.

The constraint system 240 enforces a projection constraint in relation to a query. For example, the constraint system 240 may prohibit an output to a query from including data values from any constrained columns of a shared dataset. This may include denying a query altogether based on the operations included in the query, such as if the query requests to simply output the values of a constrained column. However, the constraint system 240 may allow for many other operations to be performed while maintaining the confidentiality of the data values in the restricted columns, thereby allowing for additional functionality compared to current solutions (e.g., tokenization). For example, the constraint system 240 allows for operations that provide an output indicating a number of data values within a column that match a specified key value or values from another column, including fuzzy matches. As one example, two tables can be joined on a projection-constrained column using a case-insensitive or approximate match. Tokenization solutions are generally not suitable for these purposes.

The constraint system 240 may also allow users to filter and perform other operations on data values stored in projection-constrained columns. For example, if an email-address column is projection-constrained, an analyst end-user is prevented from enumerating all of the email addresses but can be allowed to count the number of rows for which the predicate “ENDSWITH (email, ‘database_123’)” is true. The constraint system 240 may provide an output to the query to a requesting user's client device.

However, the constraint system 240, cannot protect individual privacy with projection constraints by themselves; enumeration attacks are possible, aggregate queries on non-constrained attributes are possible, and covert channels are possible.

FIG. 3 is a block diagram 300 illustrating components of the execution platform 110 of FIG. 1, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, additional embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4 is a block diagram 400 illustrating components of the aggregation system 250 as described and depicted in connection with FIG. 2, according to some example embodiments. As explained above, databases are used by various entities (e.g., businesses, people, organizations, etc.) to store data. For example, an entity using a database can include a retailer that may store data describing purchases (e.g., product, date, price, etc.) and the purchasers (e.g., name, address, email address, etc.). Similarly, an entity using a database can include an advertiser that may store data describing performance of their advertising campaigns, such as the advertisements served to users, date that advertisement was served, information about the user, (e.g., name, address, email address, etc.), and the like.

In some cases, entities may wish to share their data with each other. For example, the retailer and the advertiser may wish to share some or all of their respective data to determine the effectiveness of an advertisement campaign, such as by determining whether users that were served advertisements for a product ultimately purchased the product. In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like. As another example, entities sharing data may wish to maintain the confidentiality of individuals in their proprietary datasets.

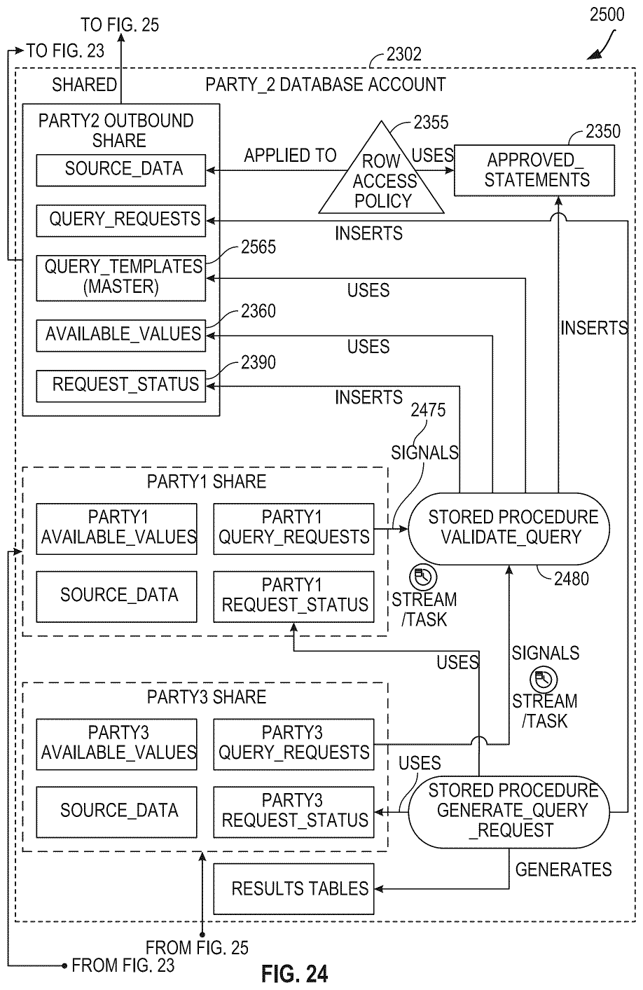

The aggregation system 250 as depicted in the block diagram 400 provides for components to enable entities to share data while maintaining confidentiality of private information. The aggregation system 250 can be implemented within the cloud data platform 102 when processing requests (e.g., queries) directed to shared datasets. For example, in some embodiments, the aggregation system 250 can be implemented within a clean room provided by the data clean room system 230 as described and depicted in connection with FIG. 2, FIGS. 24-28, or combinations thereof.

As shown in FIG. 4, the aggregation system 250 includes an aggregation constraint generation component 401, a query receiving component 402, a data accessing component 403, a table identification component 404, an aggregation constraint determination component 405, a query context determination component 406, an enforcement determination component 407, and an aggregation constraint enforcement component 408. Although the example embodiment of the aggregation system 250 includes multiple components, a particular example of the aggregation system can include varying components in the same or different elements of the cloud data platform 102.

The aggregation constraint generation component 401 enables entities to establish aggregation constraints (e.g., aggregation constraint policies) to shared datasets. For example, the aggregation constraint generation component 401 can provide a user interface or other means of user communication that enables one or more entities to define aggregation constraints in relation to data associated with a provider or consumer, where the data is maintained and managed via the cloud data platform 102. The aggregation constraint generation component 401 can allow a user of the cloud data platform 102 to define an aggregation constraint, such as an aggregation policy to provide a set of guidelines and rules that determine how data is collected, processed, managed, presented, shared, or a combination thereof for data analysis.

The aggregation constraint generation component 401 enables users to provide data defining one or more shared datasets and tables to which the one or more aggregation constraints should be attached. Further, the aggregation constraint generation component 401 enables users to define conditions for triggering the aggregation constraint, which can include defining the specific context(s) that triggers enforcement of (e.g., application of) the aggregation constraint. For example, the aggregation constraint generation component 401 can enable users to define roles of users, accounts, shares, or a combination thereof, which would trigger the aggregation constraint and/or are enabled to aggregate the constrained table of data.

The query receiving component 402 receives a query (e.g., request) directed to one or more shared datasets. The query can include information defining data to be accessed, shared, and one or more operations to perform on the data, such as any type of operation used in relation to data maintained and managed by the cloud data platform 102 (e.g., JOIN operation, READ operation, GROUP-BY operation, etc.). The query receiving component 402 can provide the data associated with the query to other components of the aggregation system 250.

The data accessing component 403 accesses (e.g., receives, retrieves, etc.) a set of data based on a query received by the query receiving component 402 or other related component of the cloud data platform 102. For example, the data accessing component 403 can access data from tables or other database schema of the shared dataset that are identified by the query or are needed to generate an output (e.g., shared dataset) based on the received query. The table identification component 404 is configured to determine the table(s) associated with the data accessed by the data accessing component 403 in response to a query. The table identification component 404 can provide information (e.g., data, metadata, etc.) identifying the table(s) to other components of the cloud data platform 102 and/or to other components of the aggregation system 250, such as the aggregation constraint determination component 405.

The aggregation constraint determination component 405 is configured to determine whether an aggregation constraint (e.g., an aggregation constraint policy, aggregation policy, etc.) is attached to any of the tables identified by the table identification component 404. For example, the aggregation constraint determination component 405 determines or identifies whether a file defining an aggregation constraint is attached to or corresponds with any of the tables or other database schema identified by the table identification component 404.

The query context determination component 406 is configured to determine or identify a context associated with a received query. For example, the query context determination component 406 can use data associated with a received query to determine the context, such as by determining a role of the user that submitted the query, an account of the cloud data platform 102 associated with the submitted query, a data share associated with the query, and the like. The query context determination component 406 can provide data defining the determined context of the query to other components of the aggregation system 250, such as the enforcement determination component 407. The enforcement determination component 407 can be configured to determine whether an aggregation constraint should be enforced in relation to a received query.

If a query constraint is not attached to any of the tables, the aggregation constraint enforcement component 408 determines that an aggregation constraint should not be enforced in relation to the specific query. However, if an aggregation constraint is attached to one of the tables, the aggregation constraint enforcement component 408 uses the context of the query to determine whether the aggregation constraint should be enforced. For example, the aggregation constraint enforcement component 408 can use the context of the query to determine whether conditions defined in a file attached to or associated with the table are satisfied in order to trigger the aggregation constraint. In some examples, the aggregation constraint enforcement component 408 can use the context of the query as an input into a Boolean function defined by the aggregation constraint to determine whether the aggregation constraint is triggered and should be enforced or not enforced. According to some examples, the aggregation constraint enforcement component 408 provides different return type options to an aggregation policy. For example, the return type can be a string where the aggregation policy returns a specific formatted string to specify the allowed actions that a compiler will understand as an aggregation configuration (e.g., min_group_size>10). In additional examples, the return type can be an object where the aggregation policy body uses the object construct to specify allowed actions as a key value pair (e.g., object_construct (‘min_group_size’, 10). In additional examples, the return type can be an abstract data type (e.g., AGGREGATION_CONFIG).

The aggregation constraint enforcement component 408 can prohibit an output to a query from including data values from any constrained tables of a shared dataset. For example, this can include denying a query altogether based on the operations included in the query (e.g., if the query requests to simply output the values of a constrained table). The aggregation constraint enforcement component 408 can enable many other operations to be performed while maintaining the confidentiality (e.g., privacy) of data values in restricted tables or other database schema.

For example, an entity sharing data may define the aggregation constraints to be attached to various tables of a shared dataset. For example, the entity may define the table (e.g., tables, other schema level object(s), etc.) that the aggregation constraint should be attached to, as well as the conditions for triggering the aggregation constraint. When a query directed towards the shared dataset is received by the cloud data platform 102, the aggregation system 250 accesses the data needed to process the query from the shared database and determines whether an aggregation constraint is attached to any of the tables of the shared dataset from which the data was accessed. If an aggregation constraint is attached to one of the tables, the aggregation system 250 determines whether the aggregation constraint should be enforced based on the context of the query and generates an output accordingly. For example, if the aggregation constraint should be enforced, the aggregation system can generate, or cause to be generated, an output that does not include the data values stored in the tables but can provide an output determined based on the aggregation-constrained data.

For example, different combinations of aggregation constraint responses are considered, such as (a) rejecting the query (or request) if it queries individual rows rather than requesting one or more aggregate statistics across rows, (b) if the aggregate statistics for any given group of rows contains a sufficient number of rows (e.g., the “minimum group size”), the statistic for this group is included in the query result, (c) if the aggregate statistics for a given group does not meet the minimum group size threshold, these rows are combined into a remainder group, referred to herein as a residual group, that contains all rows for which the group size threshold was not met, and/or (d) an aggregate statistic is computed for the remainder group as well, and also included in the query result (when the remainder group itself meets the minimum group size threshold). Example embodiments can include some combinations or all combinations (e.g., parts (a) and (b) only, parts (a)/(b)/(c), or additional aggregation constraint responses may be added as described below in connection with FIG. 4).

An entity sharing data may define the aggregation constraints to be attached to various tables of a shared dataset. For example, the entity may define the table or tables (or other schema) that the aggregation constraint should be attached to, as well as the conditions for triggering the constraint. When a query directed towards the shared dataset is received by the cloud data platform 102, the aggregation system 250 accesses the data needed to process the query from the shared database and determines whether an aggregation constraint is attached to any of the tables of the shared dataset from which the data was accessed. If an aggregation constraint is attached to one of the tables, the aggregation system 250 determines whether the aggregation constraint should be enforced based on the context of the query and generates an output accordingly. For example, if the aggregation constraint should be enforced, the aggregation system 250 may generate an output that does not include the data values stored in the tables, or one or more columns of the tables, but may provide an output determined based on the constrained data, such as a number of matches, number of fuzzy matches, number of matches including a specified string, unconstrained data associated with the constrained data, and the like.

In some example embodiments, different users can specify different components of an aggregation constraint. For example, users can select one or more of the data to be protected by the constraint, the conditions under which the constraint is enforced (e.g., my account can query the raw data, but my data sharing partner's account can only query it in aggregated form), a minimum group size that queries must adhere to (e.g., each group must contain at least this many rows from the source table), and/or the class of aggregate functions that can be used for each attribute.

In some example embodiments, the aggregation constraint system includes receiving a constraint to a database table from the data steward (e.g., provider). The constraint specifies which principals (e.g., consumers, analysts, roles, etc.) are subject to the constraint, where a principal refers to an entity or user that can be granted permissions or access rights to system resources. For example, a principal can represent a user, group of users, application, or the like relating to a security framework with a central role in authorization, authentication, accountability processes, and the like (e.g., group principal, service principal, user principal, etc.). The constraint also specifies, for each principal who is subject to the constraint, the minimum number of rows that must be aggregated in any valid query. If a query does not meet this minimum, data is suppressed or the query is rejected, indicating an invalid query. Aggregation constraints work with data sharing and collaboration, provided that the sharing occurs on a common, trusted platform. In some example embodiments, the constraint is enforced by a common trusted data platform, (e.g., the cloud data platform). In additional example embodiments, the constraint could be enforced without the need to trust a common platform by using either (a) homomorphic encryption or (b) confidential computing.

In some example embodiments, the aggregation system 250 allows multiple sensitive datasets, potentially owned by different stakeholders, to be combined (e.g., joined or deduplicated using identifying attributes such as email address or social security number). The system enables analysts, consumers, and the like to formulate their own queries against these datasets, without coordinating or obtaining permission from the data owner (e.g., steward, provider, etc.). The system can provide a degree of privacy protection, since analysts are restricted to query only aggregate results, not individual rows in the dataset. The data steward/owner/provider can specify that certain roles or consumers have unrestricted access to the data, while other roles/consumers can only run aggregate queries. Furthermore, the provider can specify that for roles/consumers in the latter category, different consumers may be required to aggregate to a different minimum group size. For example, a highly trusted consumer may be seeing only aggregate groups of 50+ rows. A less trusted consumer may be required to aggregate to 500+ rows. Such example embodiments can express aggregation constraints as a policy, which can be a Structured Query Language (SQL) expression that is evaluated in the context of a particular query and returns a specification for the aggregation constraint applicable to that query.

In some example embodiments, the aggregation system 250 performs operations on the underlying table within the database built into the cloud data platform. The cloud data platform, or a trusted database processing system, can perform the aggregation policies according to different example embodiments as described throughout.

Enforcing aggregation constraints on queries received at the cloud data platform 102 allows for data to be shared and used by entities to perform various operations without the need to anonymize the data. As explained throughout, in some example embodiments, the aggregation system 250 can be integrated into a database clean room, as depicted and described above with reference to FIGS. 22-28, and/or used in conjunction with, parallel to, or in combination with the constraint system 240 as depicted and described above with reference to FIG. 2. The database clean room enables two or more end-users of the cloud data platform 102 to share and collaborate on their sensitive data, without directly revealing that data to other participants.

As an example, and in accordance with some example embodiments, the aggregation system 250 can implement aggregation constraints in a clean room to perform database end-user intersection operations (e.g., companies A and Z would like to know which database end-users they have in common, without disclosing PII of the user's customers). For instance, a company can implement the aggregation system 250 to provide enrichment analytics. In additional example embodiments, the aggregation system 250 can be implemented in a clean room to perform enrichment operations.

In some example embodiments, aggregation constraints can be enforced by aggregation system 250 when a query is submitted by a user and compiled. An SQL compiler of the aggregation system 250 analyzes each individual table accessed based on the query to determine the lineage of that table (e.g., where the data came from). In some example embodiments, the constraint-based approach of aggregation system 250 is integrated in an SQL-based system as discussed, here, however it is appreciated that the constraint-based approaches of the aggregation system 250 can be integrated with any different query language or query system, other than SQL, in a similar manner. In this way, a user submits a query, and the aggregation system 250 determines the meaning of the query, considers any applicable aggregation constraints, and ensures that the query complies with applicable constraints. In some example embodiments, if the data is from an aggregation-constrained table(s), then the aggregation system 250 checks whether the aggregation constraint should be enforced based on context, such as the role of the user performing the query. If the aggregation constraint is intended to be enforced, then the aggregation system 250 prevents the column, or any values derived directly from that column, from being included in the query output. In some example embodiments, the aggregation system 250 implements constraints using a native policy framework of the cloud data platform 102 (e.g., dynamic data masking (column masking) and Row Access Policies). In some example embodiments, similar to a masking policy of the cloud data platform 102, the aggregation system 250, via the data provider, attaches a given aggregation constraint policy to one or more specific tables. In these example embodiments, the aggregation constraint policy body is evaluated to determine whether and how to limit access to that table when a given query is received from a consumer end-user.

Additional example embodiments provide different forms of constraints to give providers more ways to protect their data. For example, providers can be enabled to limit the rate at which consumers can issue queries, the fraction of the dataset the consumer can access (e.g., before or after filters are applied), and/or the types of data that can be combined together in a single query. In additional example embodiments, differential privacy can be implemented by a DP-aggregation constraint. Further examples provide enhanced audit capabilities to allow providers to closely monitor how consumers are using provider data. For example, a provider can find out if a data consumer is crafting a sequence of abusive queries to attempt to expose PII about a specific individual.

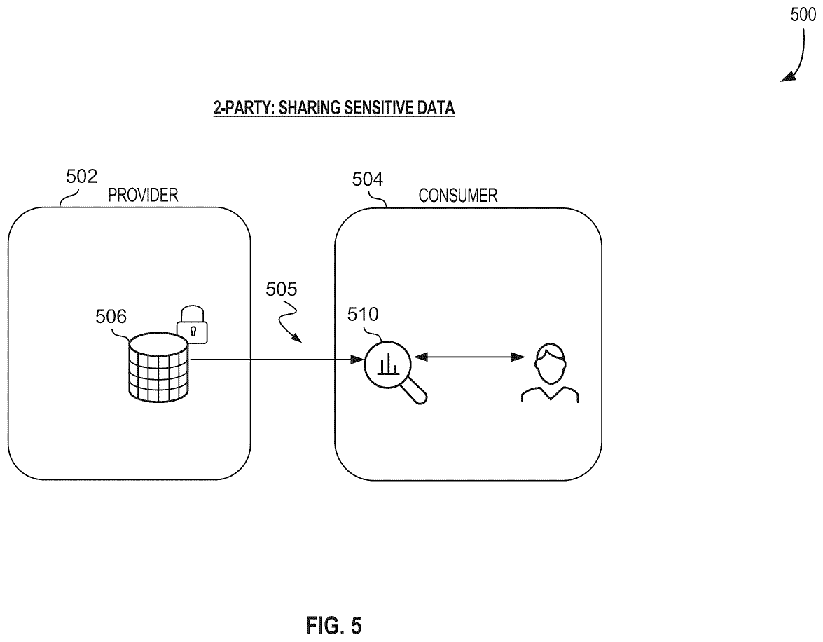

FIGS. 5-9 illustrate various data sharing scenarios in which aggregation constraints can be implemented, in accordance with some example embodiments.

FIG. 5 illustrates a data sharing scenario 500 in which a provider 502 shares their data with a consumer 504, according to some example embodiments. The example in FIG. 5 provides a simple data sharing scenario including a provider sharing data with one or more consumers, whether the consumer's queries must satisfy the aggregation constraints of the provider. In this type of scenario, the shared data 506 (e.g., shared dataset) is associated with and managed by a single entity (e.g., provider 502) and shared 505 with one or more other entities (e.g., consumer 504), according to some example embodiments. The shared data 506 is therefore not a combination of data provided by multiple entities. In this type of scenario, the aggregation system 250 can be implemented to enforce aggregation constraints on queries 510 submitted by the consumer 504. The provider 502 can implement aggregation constraints to protect any sensitive data (e.g., PII) by dictating which tables of data cannot be aggregated by the consumer 504. For example, the provider 502 may establish an aggregation constraint to prohibit each of the consumer 504 from aggregating data in a protected table or set an aggregation constraint to vary whether the data can be aggregated based on the context of the query, such as which consumer 504 submitted a query. According to the example embodiment of FIG. 5, a provider user shares data with one or more consumer users, where the consumer queries must satisfy the provider's query constraint (e.g., aggregation constraint). In the two-party sharing of sensitive data, information flow is unidirectional.

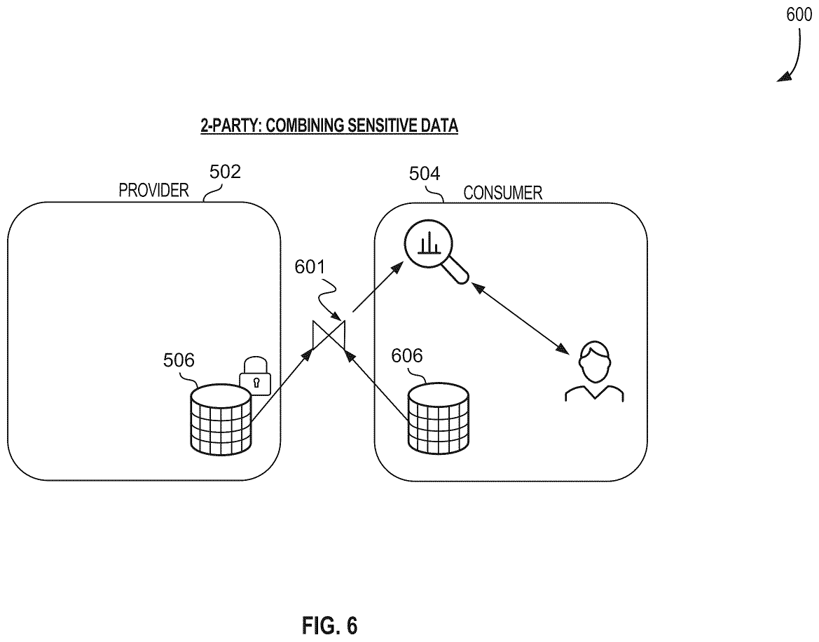

FIG. 6 illustrates a data sharing scenario 600 in which a provider 502 shares data with a consumer 504 and the shared data 506 is combined 601 with the consumer's data 606, according to some example embodiments. In this type of scenario including the combination of sensitive data, the shared data 506 is associated with and managed by a single entity (e.g., provider 502) and shared with one or more other entities (e.g., consumer 504), which combine the shared data 506 with the consumer's own data 606.

For example, combining data from two parties can include a provider sharing data in a database table that is protected by one or more aggregation constraints with a consumer. The consumer queries the database table, where the queries combine provider data and consumer data. The cloud data platform 102 enforces the provider's constraints on the consumer's queries. In this type of scenario, the aggregation system 250 can be implemented to enforce aggregation constraints on queries submitted by one or more consumers, such as consumer 504. The provider 502 can implement aggregation constraints to protect any sensitive data by dictating which tables of data cannot be used by the consumer 504 via queries, while allowing the consumer 504 to perform operations on the shared data 506 based on the consumer's data 606.

For example, the consumer 504 can perform operations to determine and/or output a number of matches between the consumer's data 606 and data in the constrained tables of the shared data 506 but may be prohibited from aggregating the data values of the constrained tables. As in the example shown in FIG. 5, the provider 502 can establish an aggregation constraint to prohibit each of the consumer 504 from aggregating data in a protected table or set an aggregation constraint to vary whether the data can be aggregated based on the context of a query, such as which consumer 504 submitted a query. According to the example embodiment of FIG. 6, a provider user shares data protected by one or more aggregation constraints with one or more consumer users, such as consumer 504. The consumer user's queries are combined with provider data and consumer data, where the cloud data platform or component thereof (or trusted database processing system) enforces the provider user's aggregation constraints. In the two-party combining of sensitive data, information flow can be unidirectional or bidirectional.

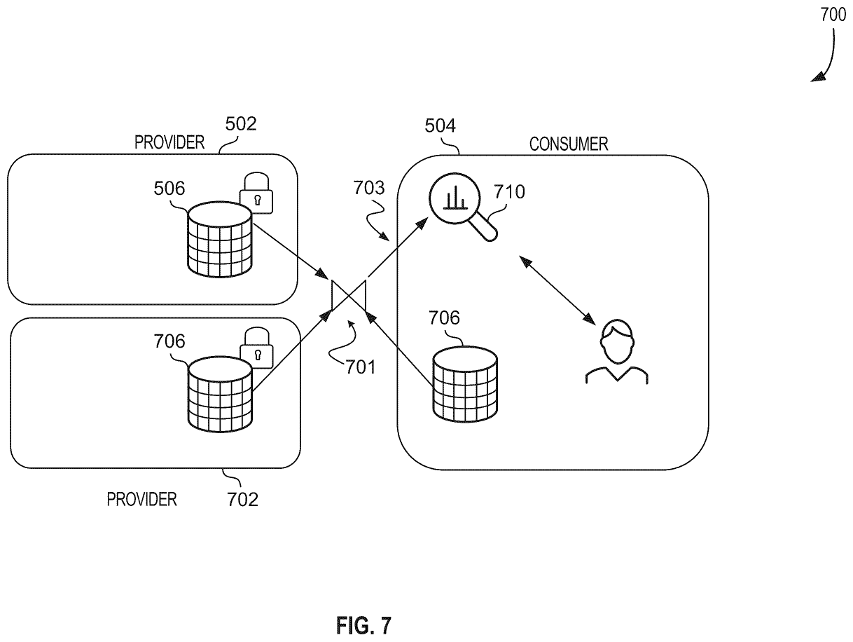

FIG. 7 illustrates a data sharing scenario 700 in which data shared by multiple providers, such as provider 502 and provider 702, is combined via a share 701 and shared with a consumer 504, according to some example embodiments.

In an example combining data from N parties, N−1 providers share data with a consumer and the consumer's queries must satisfy all N providers' constraints. In this type of scenario, the shared data 506 and 706 is a combination of data associated with and managed by multiple entities (e.g., provider 502 and provider 702) and the shared data 506 and 706 is shared 703 with one or more other entities (e.g., consumer 504). In this type of scenario, the aggregation system 250 can be implemented to enforce aggregation constraints on queries submitted by the one or more consumers, such as consumer 504. Each of the providers 502 and 702 can implement aggregation constraints to protect any sensitive data shared by the respective provider by dictating which tables of the data cannot be aggregated by the consumer 504. In this type of example, a query 710 submitted by a consumer 504 can be evaluated based on the aggregation constraints provided by each of the provider 502 and the provider 702.

The shared data 506 and 706 can be accessed by the consumer 504 without being combined with the consumer's data 706, as shown in FIG. 5, or the consumer 504 can combine the shared data 506 and 706 with the consumer's own data 706, as shown in FIG. 6. Each provider 502 and 702 can establish aggregation constraints to prohibit each of the consumers, such as the consumer 504, from aggregating data in a protected table or set an aggregation constraint to vary whether the data can be aggregated based on the context of a query, such as which consumer 504 submitted a query 710. According to the example embodiment of FIG. 7, data is combined from N number of parties, where N−1 providers share data with one or more consumers, and all consumer queries must satisfy all providers' aggregation constraints. In the N-parties combining of sensitive data, information flow can be unidirectional, bidirectional, and/or multidirectional.

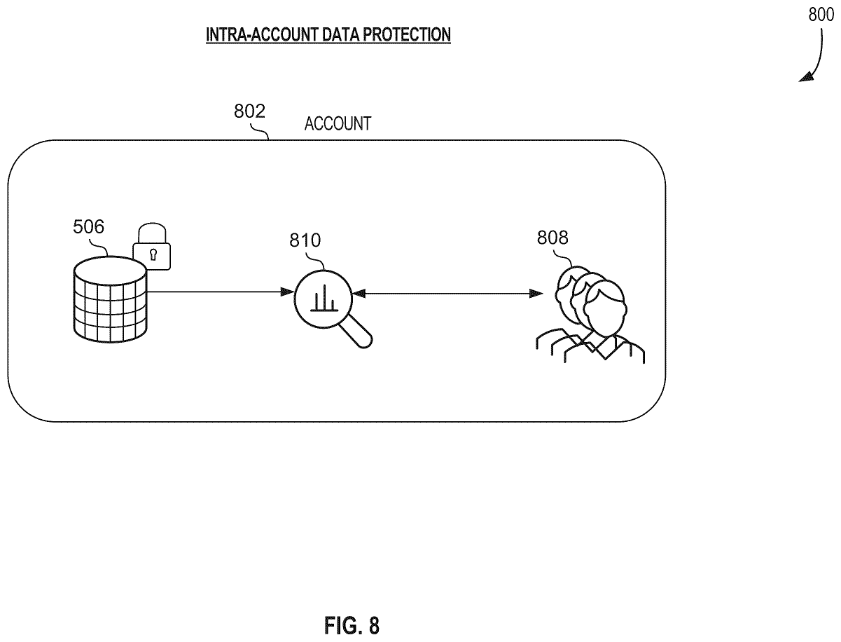

FIG. 8 illustrates a data sharing scenario 800 in which a provider of an account 802 shares data with internal users 808, according to some example embodiments.

In this type of scenario, the shared data 506 is data associated with and managed by a single entity (e.g., account 802) and the shared data 506 is shared with one or more other users associated with the entity (e.g., internal users 808). In this type of scenario, the aggregation system 250 can be implemented to enforce aggregation constraints on queries submitted by the one or more internal users. The account 802 can implement aggregation constraints to protect any sensitive data shared by the account 802 by dictating which tables of the data cannot be aggregated by the internal users 808. For example, the account 802 can establish aggregation constraints to prohibit each of the internal users 808 from aggregating data in a protected table or set an aggregation constraint to vary whether the data can be aggregated based on the context of a query, such as the role of the internal users 808 that submitted a query 810.

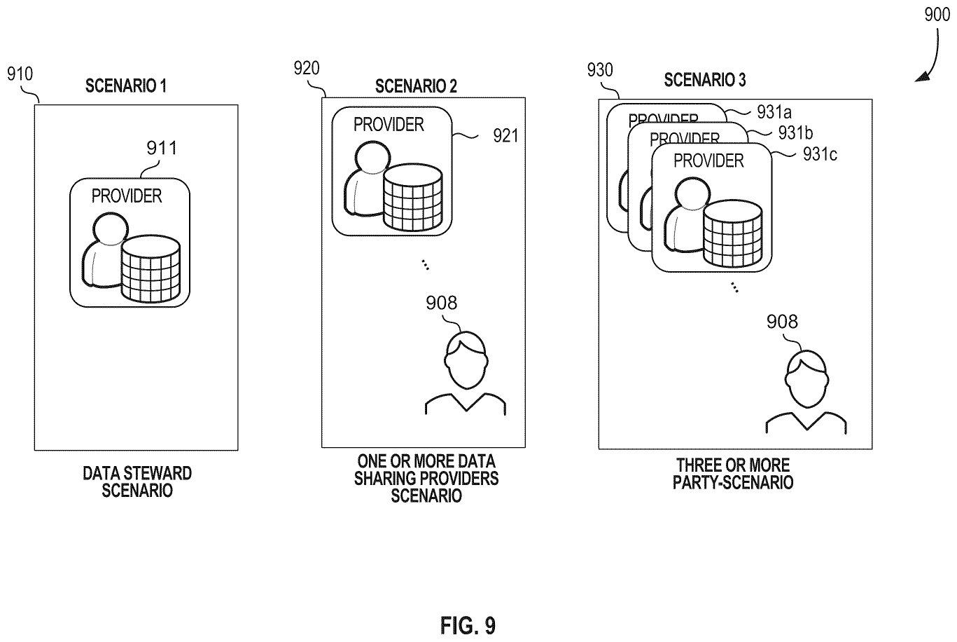

FIG. 9 illustrates a block diagram 900 in which varying example embodiments of an aggregation constraint system can be implemented, in accordance with some example embodiments. Example embodiments of FIG. 9 provide additional examples to FIGS. 5-8.

Aggregation constraints include a specific type of query constraint that enable data analysts to analyze a set of data and enable cloud data platform users to share data with data analysts, while ensuring that the data-sharing entity (e.g., user publishing data) can maintain a level of control over how the data can be queried (e.g., how the data can be used). While a projection constraint is useful for maintaining confidentiality and/or anonymity of proprietary datasets, the projection constraints fail to protect individual privacy (e.g., the privacy of each customer or each user).

The aggregation constraint system provides cloud data platform users with aggregation constraints to maintain individual customer privacy of each customer of a user (e.g., provider, consumer, combination). A provider or data steward can share a secure view of a dataset including customer PII and include an aggregation constraint to the secure view. A consumer can JOIN the provider's secure view against the consumer's customer list, but the consumer is restricted or prohibited from including the provider's customer list in the query output based on the provider's aggregation constraints.

In a first scenario 910, such as data steward scenario, a single organization illustrates a data steward 911 (e.g., data provider) that makes aggregation-constrained data available to data consumers (e.g., data analysts). For example, a data steward applies an aggregation constraint to a table in which each row contains sensitive information about individuals (e.g., name, address, gender, age, income, occupation, etc.). The data steward can be a data owner or data provider, such as provider 911, that ensures the quality, security, compliance, and the like of data processed and stored in the cloud data platform. In the first scenario 910, an analyst can run aggregate queries against a table (e.g., average income grouped by occupation) but cannot run queries that target specific individuals. In additional example embodiments, a data steward specifies a minimum group size of 25 rows, and it is understood that each group will represent an aggregation of at least 25 individuals, i.e., each row corresponds to a unique individual. However, in other example embodiments, this assumption is not true of some tables, particularly for transactional data. For example, if an advertisement platform has recorded multiple advertisement impressions for a single user, that user might have multiple records in an ad_impressions table. Additional example embodiments allow the data steward to designate a relation (e.g., table, column, view, etc.) that identifies the user. A minimum group size could be enforced in terms of unique users instead of rows, and some join restrictions can be relaxed (e.g., entity-level privacy).

In a second scenario 920, one provider 921 and once consumer 908 (e.g., different organizations that collaborate in a data clean room using aggregation constraints to protect their data) is illustrated. For example, in such a scenario where one or more data providers are sharing data, the data-sharing provider 921 can make or implement one or more aggregation-constrained tables available to a data sharing consumer 908. Data sharing consumers can query these aggregation-constrained tables, join these tables with data from other providers, and join these tables with the consumers' own data. These JOIN operations can use identifying and/or quasi-identifying attributes of individuals (e.g., email addresses), or the operations can use non-identifying data or abstractions. The aggregation constraint system can ensure that consumers' queries abide by all relevant aggregation constraints, such that the results will be appropriately aggregated.

For example, according to the second scenario 920, including one data-sharing provider, an advertising platform and an advertiser can share data that includes PII. The advertising platform (e.g., the provider) may share an aggregation-constrained table of customers who saw an advertisement. The advertiser (e.g., the consumer) can use an identifying attribute, such as an email address or phone number, to join this table against a second table owned by the advertiser (e.g., the consumer), which contains the customers who purchased the advertiser's product. The aggregation constraint permits the advertiser (e.g., the consumer) to execute a query that performs this JOIN operation, and then aggregates to compute the total number of customers who saw the advertisement and also purchased the product. The aggregation constraint system can enable the constraint to ensure that the advertiser cannot run unaggregated queries against the specific rows (e.g., customers) in the provider's table.

In a third scenario 930, multiple data providers and a single consumer are shown. For example, in a multiple-party scenario, aggregation constraints can be used in example embodiments with three or more providers, such as providers 931a/931b/931c/931n. For example, the advertiser and advertising platform in the previous example enlist the help of an identity resolution provider. The advertising platform maintains a table of advertisement impressions. According to the third scenario, the fields that identify a given consumer can be similar or different between two companies (e.g., consumer always provides the same email to all companies or sometimes the consumer provides their phone number, other times their email, still other times their address and email, etc.). Enabling two or more companies to match identities across their different customer lists requires an identity provider (e.g., a third party) to provide the bridge to actually match the customers based on their different identifying or quasi-identifying attributes.

For example, in the advertisement technology space, there can be standalone companies (e.g., Company B) whose main role is to match identities across companies. The standalone company provides an identifier (e.g., unique identifier (UID)) for each customer that is unique per company the customer contracts with. For example, customer, User A, has a first unique identifier from the advertising platform and a second unique identifier from the advertiser, but the standalone company generates a wholly unique customer identifier that matches both company-specific identifier values (e.g., a bridging UID matching both the advertising platform UID and the advertiser UID for customer User A).

In additional example embodiments, the third scenario of identity resolution aggregation constraints can be implemented in a data clean room, enabling data-sharing companies to match customer records and then perform additional operations (e.g., augmentation/enrichment, audience creation, reach, frequency, measurement, etc.). These data-sharing providers are foundational to much of the cross-company clean room collaboration that can be performed in the advertising technology space.

Additional example embodiments of an aggregation constraint system or aggregation system can be implemented to join and aggregate audience overlaps with segment creation operations. For example, when advertisers (e.g., shoe companies, exercise equipment companies, etc.) want to run advertisements on an advertisement platform (e.g., video sharing platforms, television platforms, etc.), they want to perform two actions before targeting consumers. First, advertisers want to understand what percentage and total number of their customer base are using the service. Second, advertisers want to understand how different customer segments are using the specific advertisement platform. For example, an exercise equipment company wants to know the total number of their customers watching different television programs from a specific television platform. They can then use this to run advertisements on the programs that have the highest viewership of their customers with the desire to target non-customers and drive purchasing a bike or treadmill.

Additional example embodiments of an aggregation constraint system can be implemented to join and aggregate to provide each operation. For example, when advertisers are choosing the advertisement platform that they want to run their advertisements on, the platform will commit to the total size of the audience that they will serve the advertisement X number of times. Advertisers commit to this metric, and they evaluate this metric, along with frequency, during the measurement phase. The queries that advertisers will run are joins across the advertiser's audience and segments and the population of customers that were served the advertisements on the advertisement platforms service. They will then count the total number of consumers that match and were served this advertisement.

Additional example embodiments of an aggregation constraint system can be implemented to join and aggregate to provide frequency operations. For example, advertisers want to know that the advertisement was not shown 10 million times to 1000 customers, they commit to and report on the distribution of the number of customers and times that have seen the specific advertisement campaign. The queries that advertisers will run are joins across the advertiser's audience and segments and number of customers that saw the advertisement campaign N times (resulting in the distribution).

Additional example embodiments of an aggregation constraint system can be implemented to join and aggregate to provide measurement operations. For example, when an advertisement has been run on a platform the advertisement platform will provide the advertiser with a measurement of the audience reach for a given advertisement campaign across all channels that an advertisement platform offers. Today this requires an advertisement platform to provide reporting on viewership and advertisement campaign performance across their streaming channels (e.g., web, mobile, television, etc.). Another, longer term measure, is being able to connect the customers that were served an advertisement on an advertisement platform and purchased a product in the advertiser's store. This can involve combining the advertisement platforms advertisement serving data with the advertisers' customer records and purchase history.

Additional example embodiments of an aggregation constraint system can be implemented in various other use cases.

For example, the aggregation constraint system can be used for customer intersection. In such an example, two companies are considering a partnership, and wish to aggregate statistics, such as quantifying the number of joint customers that are of high strategic value, without being able to query the status of a specific company. However, they do not want to share their respective customer lists with each other. The matching process will typically use identifying attributes, such as company name, website Uniform Resource Locator (URL), or a Content Index Key (CIK) (a unique identifier assigned by the SEC). The companies may also want to exchange additional attributes about their customers. For example, they may wish to indicate which customers are of high strategic value.

For example, the aggregation constraint system can be used for fraud detection. In such an example, financial institutions share information with each other to detect fraud and other financial crimes, while simultaneously protecting customer data. For example, the aggregation constraint system can be used for aggregate queries on de-identified data. In such an example, de-identified data is often shared for purposes such as medical research and collaborative machine learning. The intended use cases for this data typically look at records in aggregate. Unfortunately, so-called de-identified records can often still be traced back to individuals. The risk of re-identification can be greatly reduced by only permitting aggregate queries on the data. The aggregation constraint system enables de-identified data sets to be shared, without allowing consumers to inspect individual records. The cloud data platform's k-anonymization component can address similar requirements, where aggregation constraints can be used instead of, or in addition to, k-anonymity.

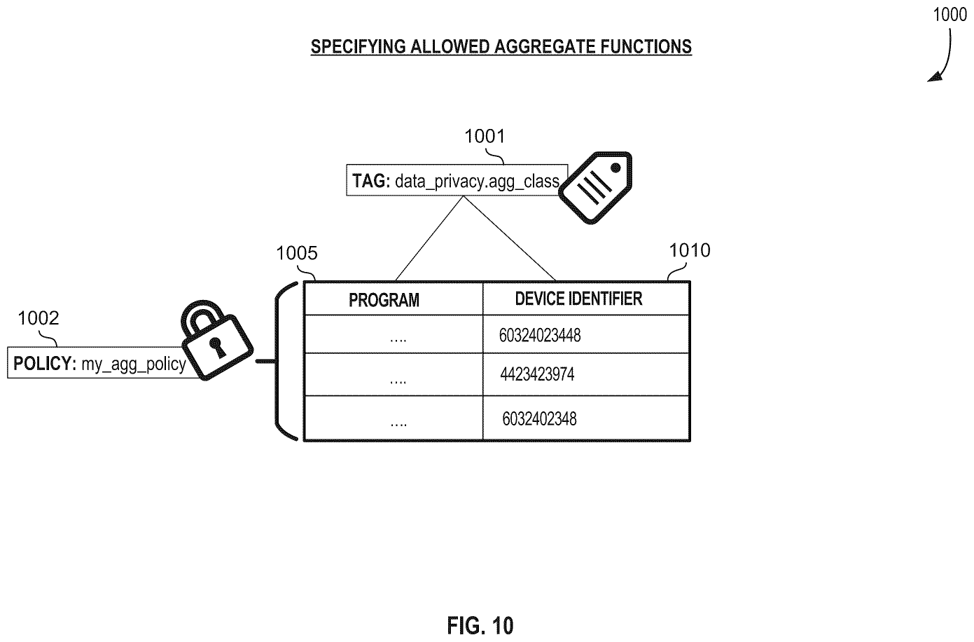

FIG. 10 is an example illustration of an aggregation policy 1000 specifying allowed aggregate functions, according to some example embodiments.

Providers of the cloud data platform 102 can specify allowed aggregate classes using a system tag 1001 (e.g., data_privacy.agg_class), according to some example embodiments. For example, an aggregation constraint policy 1002 (e.g., my_agg_policy) can include a program 1005 column to be used as a grouping key and a device identifier 1010 column to be used with one or more linear aggregation functions (e.g., COUNT, DISTINCT, etc.). In some examples, aggregation constraints (e.g., minimum group size, aggregation class, etc.) can be expressed at the column level using policies to provide different minimum group size depending on which attributes are selected or different aggregate function classes for different consumers.

In some example embodiments, users (e.g., customers of the cloud data platform) can specify allowed aggregate operators on a per-column basis. Since aggregation policies are attached at the table level, this property is not part of the policy itself. Instead, a system tag 1001 is used (e.g., data_privacy.agg_class) to specify the allowed class for each column. Tag-based policies, alone or in combination with support for tag propagation, can provide a way to ensure that when users derive data from sensitive data (e.g., through a view, CTAS, etc.), the derived data can inherit the policy protections of the source data.

In additional example embodiments, the granularity of aggregation constraints and/or aggregate classes can be specified or changed. For example, aggregation constraints can be specified at the table level, while the classes can be specified via tags at the column level. In such example embodiments, the user has a table where each row contains sensitive data about an individual. All queries about those individuals can be aggregated to protect individual privacy. The aggregation class can be a property of the data type. In additional example embodiments, each column can have its own aggregation constraint, where aggregation is enforced depending on which columns are accessed in the query.

In additional example embodiments, aggregation constraints can be expressed at the column level (opposed to the table level or other schema level) using policies (e.g., policy 1002). For example, different aggregate function classes for different consumers can be applied and different minimum group sizes can be applied depending on which attributes are selected.

In additional example embodiments, an aggregation policy can be set on a view, regardless of whether the source table(s) are aggregation constrained or not. When there are multiple levels of aggregation constraints, the most restrictive (e.g., largest) minimum group size is selected and applied on the first level aggregate so that the data is most protected. For example, considering a query Q ran against a view ‘foo_v’ whose source table is ‘foo’: If view ‘foo_v’ and table ‘v’ both have an aggregation policy set with min_group_size=>50 for ‘foo_v’ and 10 for ‘v’, the most restrictive (e.g., largest) minimum group size will be chosen to be applied to the first level aggregate. A table policy will only be applied to the first level aggregate (e.g., if the view definition has an aggregate) if the policy on ‘foo’ is applied to it and the next level aggregate query Q will not have the policy applied. If the view has a policy, the view policy will be applied to the query Q at the top-level aggregate. If the view definition does not have an aggregate, the policy will be applied to query Q at the top-level aggregate. If the view also has a policy, the most restrictive one (between ‘foo_v’ and ‘foo’) is selected.

In additional example embodiments, when an aggregation constraint is attached to a view, the constraint will be enforced for queries that access that view column, but not for queries that access the underlying table(s) directly if the underlying table(s) are not aggregation constrained. In some examples, a view will be aggregation-constraint protected if the underlying source table is also aggregation constrained.

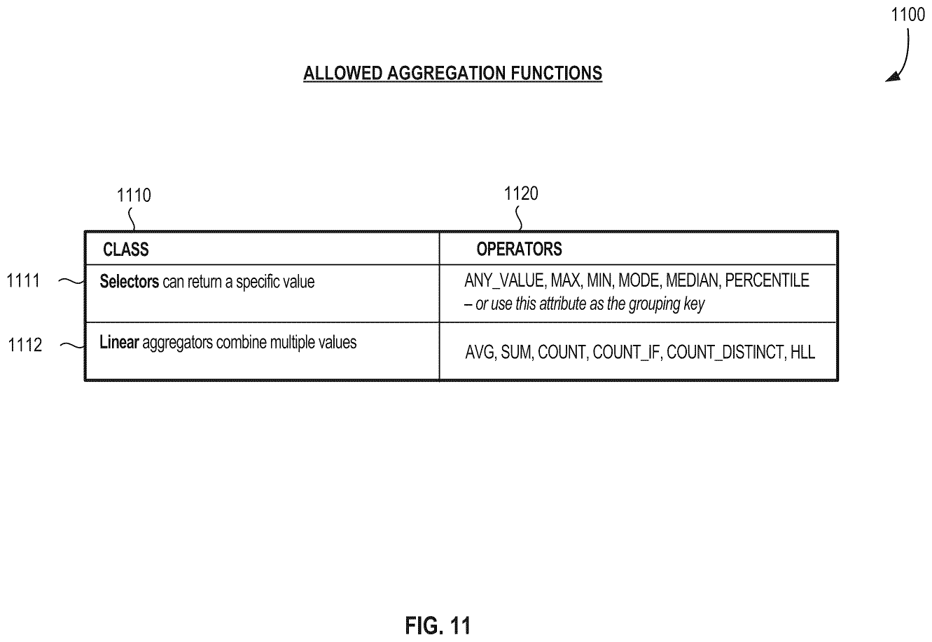

FIG. 11 is an example of a chart 1100 of allowed aggregate functions, in accordance with some example embodiments.

The aggregation system 250 can enable each provider to specify a class 1110 of aggregate operators 1120 the consumer can use in a query on a per table or per column basis. For example, providers may vary on what specific values in each table or column they are interested in sharing with consumers. For some tables (or columns), the provider allows the reveal of specific values from each group. However, for other tables (or other schema) the provider prohibits revealing specific values and allows only combinations (e.g., average, count) that obscure the input values. According to the example embodiment of FIG. 11, the class of aggregate operators can change on a per query basis, a per consumer basis, a per use basis, or other provider-determined allowable function list.

According to the example embodiment of chart 1100, the class 1110 can include selectors 1111 that can return a specific value and/or linear aggregators 1112 that combine multiple values. For example, selectors 1111 can extract a representative value from each aggregate group, such that an analyst can view the value but does not know which individual (e.g., row) has that data value. A selector 1111 can also be used as a grouping key. Example operators 1120 for class of selectors 1111 can include operators such as ANY_VALUE, MIN, MAX, MODE, MEDIAN, PERCENTILE, or the like. The linear aggregators 1112 can combine values in a method that provides each input an equal contribution in the result. Example operators 1120 for class of linear aggregators 1112 can include operators such as AVG, SUM, COUNT, COUNT_IF, COUNT_DISTINCT, Harmonic Linear Log-Log, and the like.

In some examples of permitted (e.g., allowed) aggregate functions, an aggregation policy determines whether a column can be used as an argument to the SELECTOR class of aggregate functions (e.g., MIN, MAX, ANY_VALUE, MODE, etc.). In additional examples of permitted aggregate functions, an aggregation policy determines whether a column can be used as an argument to the linear class of aggregate functions (e.g., COUNT, SUM, AVG, etc.).

In additional example embodiments, data in an aggregation-constrained table can only be returned in aggregated form, which helps to protect sensitive attributes in individual rows. Constructs that would allow for amplification may be limited or disallowed. Amplification means that a single row has an outsized impact on the output. For example, the EXP( ) function amplifies outliers, and exploding joins will amplify/duplicate rows. In some example embodiments, when an analyst (e.g., data analyst) queries an aggregation-constrained table, she may only ask questions about the data in the table in aggregate and may not access individual rows or attributes. However, aggregation constraints also allow the analyst to perform limited forms of pre-processing prior to aggregation, including limited joining, filtering, and cleaning. More specifically, in order to protect the sensitive data in the table, the cloud data platform can enforce the following rules for queries on aggregation-constrained tables:

In examples including mandatory aggregation, a query against an aggregation-constrained table must aggregate the rows in the table before outputting them. This aggregation operation is called a constrained aggregation, and it has special behavior, including enforcing a minimum size of each aggregate group.

In examples including restricting aggregate functions, only certain aggregate functions are allowed, (e.g., AVG, SUM, COUNT [DISTINCT], and HLL); however, the precise functions can differ according to different example embodiments.

In examples including limiting preprocessing prior to aggregation, the cloud data platform 102 can allow individual rows and attributes of the aggregation-constrained table to be filtered, joined, and transformed in certain ways prior to aggregation. However, there are limits on how the raw data can be manipulated. An example embodiment of limiting pre-processing prior to aggregation can be seen in connection with FIG. 10.

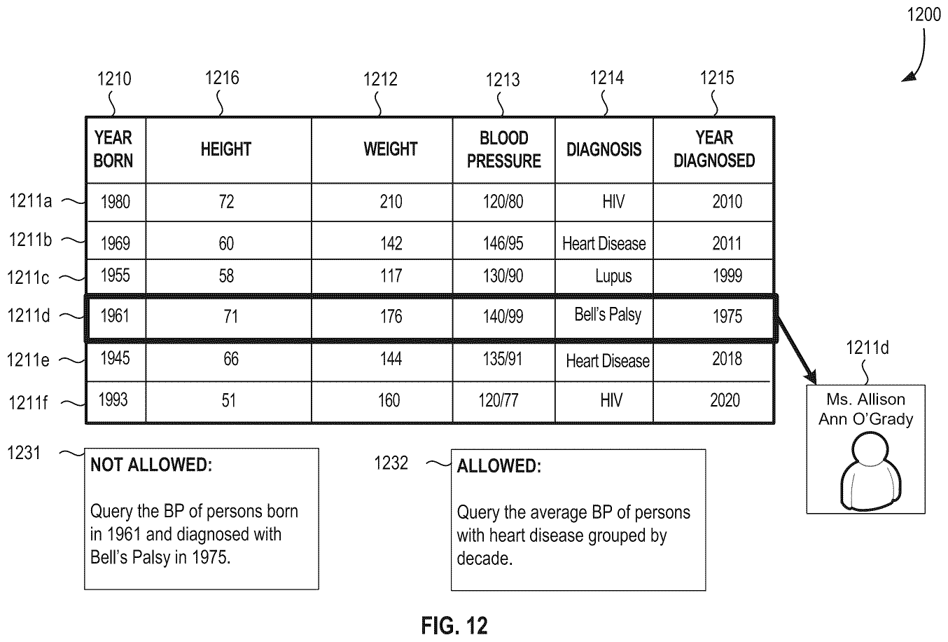

FIG. 12 illustrates an example of a table 1200 of health-related data to illustrate allowable and prohibited queries in an aggregation system, in accordance with some example embodiments. The table 1200 displays columns providing data on individual years of birth 1210, height 1216, weight 1212, blood pressure 1213, medical diagnosis 1214, and year of diagnosis 1215 including data values for six patients 1211a-f.

According to example embodiments of the aggregation system 250, aggregation constraints allow for the querying of data about groups of people (e.g., queries about the group of patients 1211a-f), but prohibit (e.g., do not allow) for the querying of data about individuals (e.g., queries about patient 1211d). In medical research, medical researchers can use the aggregation system 250 to provide insights and ask questions (e.g., queries) about correlations among attributes (e.g., weight versus mortality) across a group of patients, but not for individuals. For example, a consumer can perform a variety of operations (e.g., filter, join, etc.) on the data in table 1200 prior to aggregation, can aggregate the data in table 1200 into groups of a minimum size specified by the provider, and can perform any operations or actions with the aggregated values.

Researchers (e.g., analysts) may wish to share this data in order to perform statistical analyses, such as analyzing the relationship between certain diseases and attributes such as weight, age, and blood pressure. Unfortunately, sharing the raw, unprotected data can present a privacy risk, because the raw dataset exposes not just correlations between attributes in the aggregate, but also correlations between attributes for individuals. The aggregation constraint policy associated with (e.g., attached to) the table 1200 can provide a set of rules and guidelines to dictate how the individual data elements or objects are aggregated (e.g., combined) to produce aggregated data results. The policy may include data related to queries that are not allowed 1231, such a query of the blood pressure of persons born in 1961 and diagnosed with Bell's Palsy in the year 1975. Additionally, the aggregation constraint policy associated with (e.g., attached to) the table 1200 can include data related to queries that are allowed 1232, such as a query of the average blood pressure of persons with heart disease grouped by decade.

For example, Bell's Palsy is a relatively rare disease, affecting roughly 65,000 United States residents per year. By itself, a Bell's Palsy diagnosis does not identify an individual, but if tuples, such as <year born 1210, height 1216, weight 1212, diagnosis 1214, year diagnosed 1215>, from the table 1200 are viewed, a researcher could synthesize, from publicly available data, that the individual with Bell's Palsy in the table 1200 is probably patient 1211d, which would lead to the identification of the patient's name. In this example, the patient 1211d may not appreciate that the researchers have effectively disclosed the patient's blood pressure as well as medical diagnosis and other PII.

Example embodiments of the aggregation system could use k-anonymization, but if medical diagnoses are treated as potentially identifying, there would be a need to suppress a lot of information about individuals with rare diseases to satisfy k-anonymity. Instead, example embodiments of the aggregation system can use aggregation constraints, where instead of anonymizing the data itself, example embodiments of the aggregation system allow only aggregate queries over the data. Since aggregate queries do not expose as much information about individual rows (e.g., individual patients 1211a-f), this approach can preserve more analytical value while providing privacy protection.

Example embodiments of the aggregation system enable cloud data platform users to query shared data about groups while restricting queries about individuals. For example, the cloud data platform 102 can allow a consumer query about the average blood pressure of individuals with heart disease grouped by decade born, but would restrict queries (e.g., not allow consumer queries) of blood pressure of the individual born in the year 1961 and diagnosed with Bell's Palsy in 1975. Such an aggregation constraint would maintain the individual privacy of customers' health-related data from being deciphered by consumers using malicious or clever requests or groups of requests.

By providing queries about groups, the consumers can analyze a customer group by demographics, location, interests (e.g., advertising insights by audience breakdown) and ask questions about correlations about attributes across groups but not individuals (e.g., medical research on groups). For example, a consumer can perform FILTER and/or JOIN operations on the shared data prior to aggregation, aggregate the data into groups of some minimum size specified by the provider, and/or have unrestricted use of the aggregate values.

Example embodiments of aggregation constraints help to protect individual privacy while allowing for the aggregation of generalized group data. For example, each aggregate tuple should not reveal too much about an individual row (e.g., data values of individual rows of a table). The aggregation system provides progressively stronger (e.g., more robust) types of constraints on columns of a table in order to protect personal or sensitive data values in rows. For example, a consumer can ask any question about unconstrained columns, then a consumer can view the data values of an aggregation-constrained column only in an aggregated form.

For example, if an expression e (e.g., a query) is not derived from any constrained column, the data values of the column can be aggregated in the query result without restriction. If an expression e is derived from a projection-constrained column z, it is prohibited from being projected from a query, and thereby the projection of an aggregate is similarly prohibited. If an expression e is derived from a non-aggregate of an aggregation-constrained column y, it is not allowed to be projected from a query (e.g., y+z, pow(2, y). If an expression e is derived from an aggregate (e.g., aggfn(y1, y2, . . . )), it is not allowed to be projected in a query result if any of the following: (a) at least one argument in expression y is derived from a projection-constrained column z, (b) at least one non-constant input argument expression is not a column expression and such an expression is derived from an aggregation-constrained column (e.g., EXP(y), or (c) for at least one argument y, a policy determines that aggfn is not a permitted aggregate on column y.

According to examples, an aggregation-constrained column y can be projected if it complies with one or more characteristics. One such example characteristic includes when an aggregation constraint policy determines it to be a group key, which would permit the query SELECT y, AVG(x) FROM foo GROUP BY 1 if y is a group key. Another such example characteristic includes the corollary, where if an aggregation-constrained column y is a group key, then the aggregation system will permit a query SELECT DISTINCT y FROM foo. Where a group key is a distinct characteristic (e.g., concept) from permitting a selector-like aggregate on a column.

In the aggregation system 250, consumers (e.g., customers of data providers) may want to pre-process aggregation-constrained data (e.g., cleaning, NULL filtering, canonicalizing, filtering, joining, etc.) in a safe manner. The aggregation system can support different series of operations according to user needs or actions. The cloud data platform 102 can determine what consumers can do with the data prior to aggregation and provide for allowed, prohibited, or sometimes allowed functions. For example, the aggregation system can support a canonical pattern of consumer action of (1) selecting the population of interest (e.g., FILTER, JOIN), (2) cleaning/canonicalizing, and (3) aggregating over that population.

In additional example embodiments, the aggregation system can change the actions on a per-user basis (e.g., a per-consumer basis, a per-provider basis) and/or on a per-query basis. For example, the system can change the effect on queries based on what consumer actions on data prior to aggregation are allowed or prohibited, and expand the allowed vocabulary according to different times, needs, or actions. In one example embodiment, the system can allow filter operations, sometimes allow equality predicate operations, and not allow most transformations on column values. Where filtering operations are allowed to enable consumers to choose the population to compute aggregates on. Where equality predicate operations (e.g., JOIN operation in a relational database management system to combine rows from two tables based on a matching column value between them) are sometimes allowed when the other side of the JOIN operation must have a unique key (e.g., enforced at runtime) to prevent the consumer from joining 100 rows with the same value. Where most transformations on column values are not allowed to prevent consumers from amplifying certain values to reverse-engineer the values from the aggregate value. In other example embodiments, the system can support a class of built-in functions considered safe for cleaning data prior to aggregation (e.g., UPPER, TRIM, etc.). In some example embodiments, a join against an aggregation-constrained table must have an equality predicate, and the matched attributes from the other relation must be unique within that relation. Although relational database operations or structures are discussed here as examples, it is appreciated that in some example embodiments the data managed by the computing environment 100 can be data structured in a non-relational database format (e.g., no-SQL, Hadoop, Spark frames, etc.).

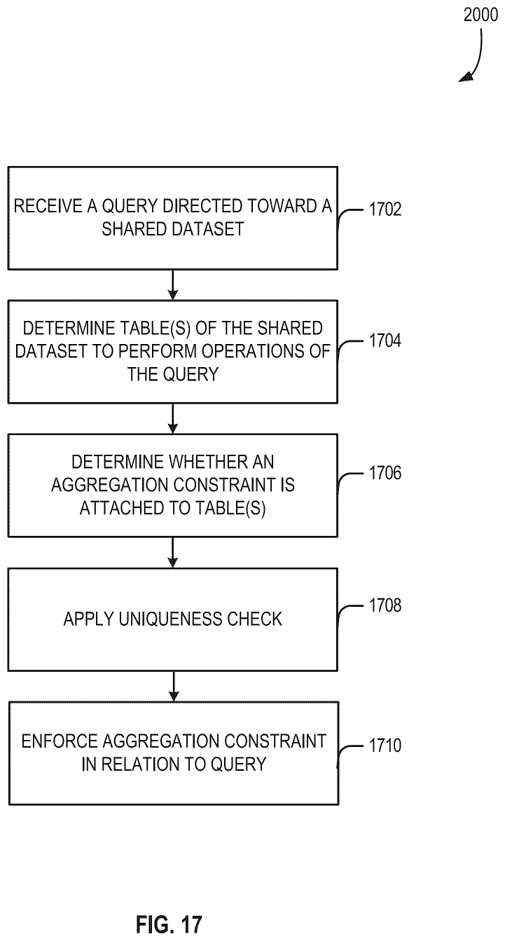

In additional example embodiments, multiple aggregation-constrained tables can be considered and the effects of JOIN operations on minimum group size is considered. For example, two aggregation-constrained relations (e.g., tables) can be joined, and in this case, a uniqueness check is applied to both sides (uniqueness checks are described and depicted in detail in connection with FIG. 17). According to examples, each aggregate group must meet the minimum group size requirement for each aggregation-constrained relation that was joined. The below examples assume that foo is an aggregation-constrained table. For example, suppose that table foo has a minimum group size of 50, and table bar has a minimum group size of 70. The constrained aggregation will require each input tuple to contain 50 rows from foo and 70 rows from bar.

For example, consider this query:
SELECT COUNT(*) FROM foo JOIN bar USING (a);

Since this is an inner join, each row produced by the join operator will contain one row from foo and one row from bar. The query will meet the group size requirement if the join produces at least 50 rows. Outer joins are more complicated, consider the following query:
SELECT COUNT(*) FROM foo RIGHT JOIN bar USING (a);

The constrained aggregation in this query may receive rows that contain only data for foo or only data for bar. To meet the minimum group size requirement, foo needs to match at least 50 rows in bar, and bar needs to contain at least 70 rows, regardless of whether those rows match foo or not. In such examples, the effect of join and filter operations order matter. For example, when there are multiple joins and filters, it is possible that the uniqueness check succeeds or fails depending on the order in which the optimizer applies joins and filters. This can cause (e.g., create) nondeterminism, so different example embodiments could: force a specific join order, perform uniqueness checks on join keys prior to applying any filters, and/or guide users to ensure that join keys are unique regardless of join order.

In additional example embodiments, the aggregation system can provide for pre-processing prior to aggregation. For example, analysts often need to pre-process inputs prior to aggregation. However, allowing analysts to pre-process the inputs arbitrarily is not safe. For example, an analyst could single out an individual easily this way in a query requesting the name based on customers, which returns the name of a specific customer, Alice.

To address this concern, example embodiments can provide for or allow only specific types of pre-processing to be performed prior to the constrained aggregation. For example, suppose that an audience insights firm wants to compute the deduplicated reach of an advertisement campaign across two streaming media platforms. These platforms each share aggregation-constrained tables with the audience insights firm. Each table contains <campaign_id, user_email, impression_count> tuples, which indicate how many times each user has seen each advertisement. The insights firm would like to do the following: (1) Filter the data in order to analyze a specific campaign. (2) Clean and canonicalize the user_email column in each table to avoid mismatches due to case sensitivity or whitespace. (3) Full outer join the tables from each channel on the user_email column. (4) Aggregate to compute the deduplicated reach and frequency. This sequence of steps (e.g., filter, clean, join, aggregate) is representative of many analytical tasks. Example embodiments support queries like this, while limiting potential attacks that would expose sensitive data of individuals in the underlying tables.

According to some example embodiments, selection and filtering can be applied, such as arbitrary filter conditions in WHERE clauses and ON clauses. Analysts can perform cleaning, canonicalization, and other computations on aggregation-constrained inputs in these clauses. In some examples, the aggregation system can apply restrictions. For example, in the above example, the restriction is that no column of an aggregation-constrained table can be logged via user defined function logging or metrics. In other examples, this restriction is enforced the same way as for projection constraints.

An evil analyst (e.g., bad actor) could try to use filters to leak sensitive information about a specific individual. The canonical way to do this is called a differencing attack. For example, suppose that the analyst wants to know Frank's salary. The analyst runs two queries:

SELECT SUM(salary) FROM employees;
SELECT SUM(salary) FROM employees WHERE name <> ‘Frank’;

Both queries meet the minimum group size requirement. However, the difference between the results of these two queries is exactly Frank's salary, which violates Frank's privacy. According to some example embodiments, the aggregation constraint may require that aggregate operators be noisy aggregate operators, which introduce random noise into the aggregate results to defeat such attacks. The random noise may be drawn from a Laplace distribution or a Gaussian distribution and may work in conjunction with other constraints (e.g., limits on number of queries that may be executed) to provide epsilon-differential privacy.

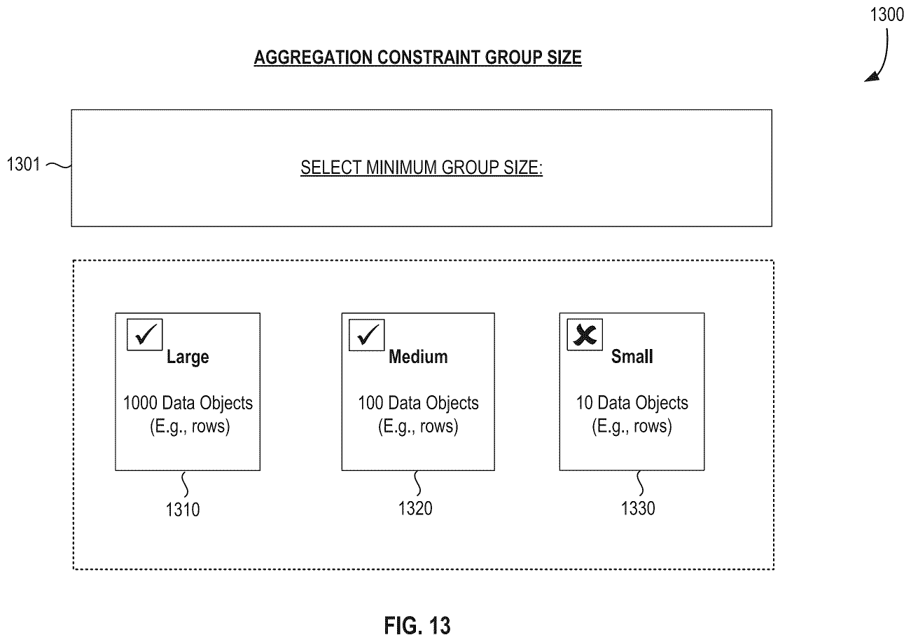

FIG. 13 is a block diagram 1300 illustrating an example aggregation constraint group size, according to some example embodiments. The cloud data platform 102 can enforce individual privacy through aggregation constraint group size by enabling providers to select larger minimum group sizes to provide better protection.

Aggregation constraints can require the data objects (e.g., rows in the aggregation-constrained table) to be aggregated into groups of a specified minimum size, where each group must have certain properties. For example, each row from the aggregation-constrained table can be represented at most once in a given group. In additional examples, each group represents at least a minimum group size (e.g., minimum number) of rows from the aggregation-constrained table, where groups that do not meet the requirement are combined into a residual group at execution time, for example. In some example embodiments, for each aggregation constraint, the provider can specify a minimum group size (e.g., select a minimum group size 1301). For example, each aggregate group must include at least the minimum number of rows from the underlying table, where groups below the specified size are organized into a residual group (e.g., a remainder group, a group for others, crumbs, leftovers, etc.) including a NULL key. In some example embodiments, if the residual (e.g., crumbs) group is non-empty but below the threshold size, the values will also be NULL. In an example of multiple constrained input tables, the minimum group size rules can be applied independently for each input table.

In example embodiments of aggregation constraint group size, a provider is responsible for selecting or picking the group size based on the provider's privacy goals, data distribution, or the like. In additional example embodiments, providers can specify different group sizes (e.g., different minimums) depending on which columns in the table are queried. For example, a provider can select, via a user interface or programming interface, a minimum group size being one or more sizes displayed to the provider as large 1310, medium 1320, or small 1330. Where large 1310 includes a minimum group size of at least 1000 data objects (e.g., rows), medium 1320 includes a minimum group size of at least 100 data objects, and small 1330 includes a minimum group size of at least 10 data objects. Different providers can be shown varying group sizes of any number that is relevant to the provider based on the provider's needs or business purposes, and it should be understood that the numbers provided in FIG. 13 are for exemplary purposes.

The aggregation system 250 enforces aggregation constraints on data values stored in specified tables of a shared dataset when queries are received by the cloud data platform 102. An aggregation constraint identifies that the data in a table may be restricted from being aggregated (e.g., joined, presented, read, outputted) in an output to a received query, while allowing specified operations to be performed on the data and a corresponding output to be provided. For example, the aggregation constraint may indicate a context for a query that triggers the aggregation constraint, such as based on the user, role, accounts, shares associated with the query, or other triggers. The aggregation constraint can be a policy that is attached to one or more tables, where the policy can consider a context (e.g., current role, account, etc.). The policy result can indicate the minimum group size for aggregation or NULL (e.g., no restriction).

According to some example embodiments, the first time an aggregation-constrained table (or view) is aggregated can be called a constrained aggregation. In a constrained aggregation, all aggregate functions must be permitted aggregate functions. In some examples, the output from a constrained aggregation is not aggregation constrained. No restrictions are placed on what queries can do with the data after it has been safely aggregated. The cloud data platform 102 or a component thereof can enforce a minimum group size on each aggregate group of a constrained aggregation. This minimum group size is specified as part of the aggregation policy attached to the aggregation-constrained table. The cloud data platform 102 can enforce the minimum group size as follows: (1) Each group must have at least as many rows from the aggregation-constrained table as the minimum group size. (2) Rows belonging to groups that are too small are combined into a remainder group. All key attributes are NULL for the remainder group (while key attributes can be NULL for other reasons related to underlying row values or due to the use of Group-By sets). (3) If the remainder group itself is too small, the aggregate values for the remainder group are NULL as well. In some example embodiments, a Group-By (or an aggregate) is a query block that (1) has a group by key, or (2) has an aggregate function.

According to some examples, an aggregation constraint is maintained as a type of policy, such as an aggregation policy or aggregation constraint policy, which can be a schema-level object. The contents of the aggregation policy can be expressed as a Lambda expression to express functionality as first-class objects that can be passed as arguments to other functions or stored in variables. Below is one possible example of applicable code to illustrate a syntax of an expression:

```
::::::CODE::::::
create or replace aggregation policy consumer_agg_100 as
  ( ) returns aggregation_config −>
    case
      when current_account( ) = ‘MY_ACCOUNT’ then aggregation_config( )
      else aggregation_config(100)
    end;
alter table sales set aggregation policy consumer_agg_100;
::::::CODE::::::
```

The expression can return an appropriate minimum group size based on context, or the expression can return NULL if no aggregation constraint should be enforced in the specific example. The aggregation constraints can be enforced at different times when an aggregation policy function is executed; for example, the aggregation constraint(s) can be enforced at compile time, execution time, or the like.

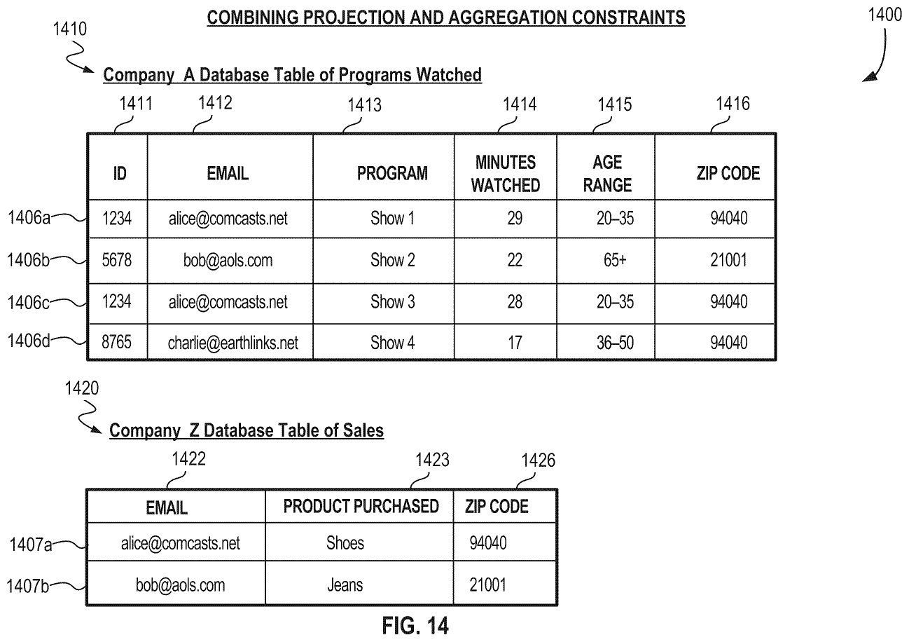

FIG. 14 is an illustration of a block diagram 1400 showing multiple user data charts for combining projection and aggregation constraints, in accordance with some example embodiments. For example, in advertising, advertising companies can use the aggregation system 250 to provide insights by dividing their audience by demographics, location, interests, and the like.

According to some examples, Company_A and Company_Z can be customers of the cloud data platform 102. In other examples, Company_A can be a customer of the cloud data platform 102 as a provider and Company_Z is a consumer, such as a customer of Company_A. According to a Company_A database table 1410 incorporating data on television programs watched, Company_A can sell advertising slots for programs on its streaming service, where Company_A has data on its customers and the television programs they watch. According to a Company_Z database table 1420 incorporating sales data, Company_Z buys advertising slots from Company_A and Company_Z has data on its customers and the products they buy. The Company_A database table 1410 includes data values for four different customers 1406a-d of Company A, which can include data that is considered PII or is otherwise specified as data that Company A desires to keep private. For example, the Company_A database table 1410 includes an identifier 1411, an email address 1412, a television program 1413, a number of minutes watched 1414, an age range 1415, and a zip code 1416. The Company_Z database table 1420 includes data values for two different customers 1407a-b of Company Z, where customer 1407a of Company Z is the same customer as customer 1406a of Company A and customer 1407b of Company Z is the same customer as customer 1406b of Company A. The Company_Z database table 1420 includes an email address 1422, a product purchased 1423, and a zip code 1426.

The example of multiple user data charts in FIG. 14, illustrates combining projection constraints and aggregation constraints to benefit both users' (e.g., Company_A and Company_Z) business goals, without sacrificing either of the users' (e.g., Company_A or Company Z) privacy goals. For example, Company Z's business goals may include using Company_A's data to perform a market segmentation analysis of its customers. However, Company Z's privacy goals may include Company Z's segmentation analysis not exposing identifying information, viewership, or demographic information about individual subscribers to Company_A.

Company_Z can run the following example query to learn what programs are most popular among age 65+ customers who also purchase shoes:

```
::::::CODE::::::
  select Company_A.program, count(distinct Company_Z.email) as
  overlap_cnt
  from Company_A join Company_Z on Company_A.email
=Company_Z.email
  where Company_Z.product_purchased = ‘shoes’
  and Company_A.age_range = ‘65+’
  group by Company_A.program;
::::::CODE::::::
```

Company_A attaches aggregation constraints (e.g., query constraints) to its data (e.g., attaches an aggregation constraint to Company_A database table 1410) before sharing the Company_A data with Company_Z for analysis. Company_A can attach the following example aggregation constraints:

```
::::::CODE::::::
  aggregation constraint on ProgramsWatched
  agg_class = SELECTOR for program, zip_code, age_range (safe to use these
as grouping keys)
  agg_class = LINEAR_AGG for other columns
::::::CODE::::::
```

In some example embodiments, Company_A can further attach (or the cloud data platform can automatically attach) aggregation constraints on one or more tables (or other schemas) when Company_Z should not output information even in aggregate form.

In additional examples, the aggregation system can include additional and/or enhanced constraints (e.g., query rate limits), or provide advanced auditing so providers can obtain consumer consent to share more query details. In additional examples, the aggregation system can incorporate rate limiting options to prevent consumers from asking too many questions or specific questions that may reveal too much of provider's data, restrict combinations of attributes, and/or constraint data volume (e.g., require selective filters, enrichment).

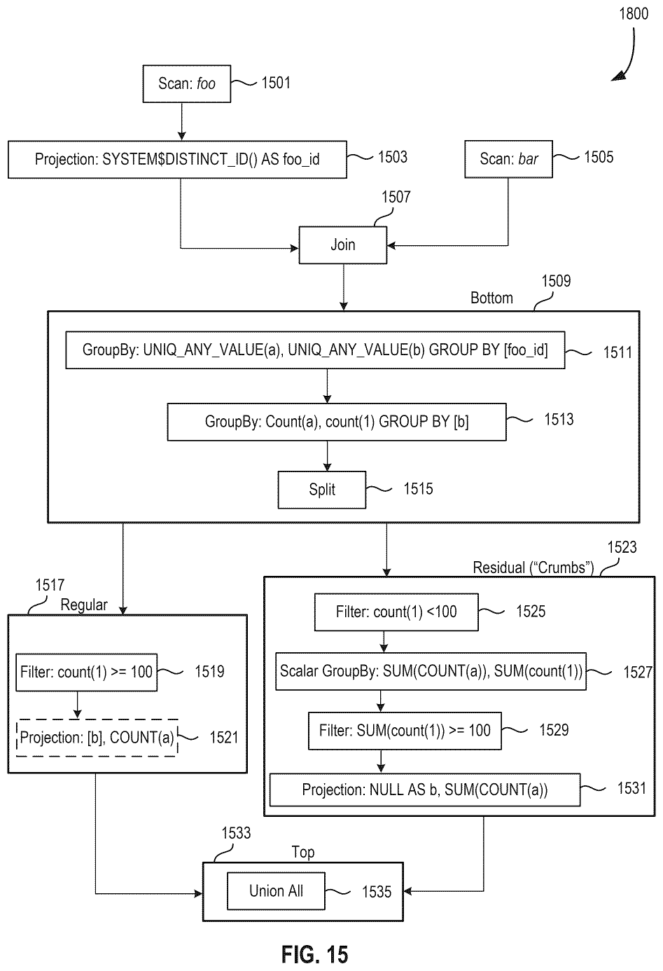

FIG. 15 includes an example of a Unified Modeling Language (UML) diagram 1500 to represent different aspects of a system of aggregation constraints, including examples of its structure, interactions, behaviors, and the like, according to some example embodiments. While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

According to the example of FIG. 15, an aggregation-constrained table foo is contemplated, where the table foo is one that has a minimum group size G_{foo} specified. The aggregation constraint stipulates that, first, a query over foo has to aggregate foo (e.g., so that SELECT AVG(a) FROM foo is allowed, whereas SELECT a FROM foo is prohibited). Making the information (e.g., data values in rows of the table that contain data records) in foo available only in aggregate form while restricting users from inquiring about individual rows. Second, the aggregation constraint stipulates that to ensure usability, two kinds of operations are permitted before aggregating data including one or more join operations and one or more filter operations. The first kind of operation includes enriching (e.g., via a join operation), for example SELECT AVG(bar.d) FROM foo JOIN bar ON a=c. In an example of enriching (e.g., join before aggregate) a join refers to either two or more objects explicitly connected through the JOIN keyword, or two or more objects listed in the FROM clause of a query block. A second kind of operation includes filtering (e.g., SELECT AVG(a) FROM foo WHERE b<42).

Third, the aggregation constraint stipulates that in order to mitigate typical tactics of suppressing or amplifying individual rows (such as AVG(EXP(x)), when aggregating over foo, any aggregate function should only have constants or column references as its arguments. This can be relaxed by allowing a small class of pre-processing operations, such as ZEROIFNULL or TRY_CAST. Fourth, the result of aggregating over foo (e.g., an aggregation operation over an aggregation-constrained table) may create a residual group. The residual group (also referred to as an “others” or “crumbs” group/portion) is a result of regrouping all of the groups that have fewer rows than the minimum group size. The residual group can include or consist of a pair (e.g., child/parent) of scalar aggregate operators responsible for computing the regrouping for all groups that fall below the minimum group size threshold. The residual group effectively re-aggregates rows that, during a regular aggregation (e.g., an unconstrained group-by), would have gone into a group with size(s) below minimum group size G_{foo}. For example, the residual group is the result of aggregating all rows in table R that have a NULL value in each of the group keys and all rows in table R that would have resulted in groups in a regular counterpart aggregation operation that are smaller than the minimum group size of a constrained aggregation operation.

According to the four constraint stipulations noted above, given a query Q and a per-table minimum group size G_{foo} for each aggregation-constrained table (or view) foo in the query Q, there can be two additional constraints to be considered according to some examples.

The first additional constraint includes statically determining, by a cloud data platform, whether a query conforms to the aggregation constraints. Specifically, the cloud data platform accepts the query Q if all of the following four properties hold true; otherwise, the cloud data platform rejects the query Q. The first property that must hold true is that each reference to an aggregation-constrained table foo is aggregated in the query Q. The second property that must hold true is that each constrained table foo only undergoes permitted relational operations (e.g., joins and filters) before it is aggregated in the query Q. The third property that must hold true is that each aggregate function in a query block that aggregates a constrained table foo only has constant or column reference arguments, or the arguments include the permitted pre-processing operations of column references. The fourth property that must hold true is that in a query block that aggregates a constrained table foo, each aggregate function that takes column reference-derived arguments must be a permitted aggregate function (e.g., COUNT and SUM).

The second additional constraint includes query plans being produced, for a query that syntactically conforms to the aggregation policies, that both enforce the non-amplification of pre-GROUP-BY joins and, for each GROUP-BY A aggregating aggregation-constrained tables, regroup smaller groups into the residual (e.g., crumbs) group. Where, in some examples, the residual group is dropped in cases where such a group is determined to be too small.

Turning to the example illustration of FIG. 15, the example UML diagram 1500 is a state machine diagram for modeling states and transitions of objects in an aggregation system, representing different conditions triggering transitions between states. The UML diagram 1500 depicts an example illustration of a diamond-shaped plan fragment for a query involving a generic aggregation function (e.g., agg( ) employing a GROUP-BY clause used to group rows from a table to perform calculations and generate summary results, according to an example embodiment.

The UML diagram 1500 begins by scanning (e.g., reading or accessing the data stored in a database table or subset of the table) a relation foo 1501 and projecting a distinct identifier for foo 1503, where foo is an aggregation-constrained table. The UML diagram 1500 additionally scans a relation bar 1505, where bar is a second table to be joined with foo. Next, the UML diagram 1500 performs a join operation 1507 of foo and bar. A relational join is one of the fundamental data processing operations used in database management by a cloud data platform. For example, the relational join operation can be employed to combine data from different tables that share a common attribute or key. A join is a binary operator taking two relations (e.g., tables) foo and bar, and a binary predicate (e.g., a specified condition, such as an aggregation constraint) as input and produces a single relation that contains the set of all combination of tuples in foo and bar that satisfy the predicate. When the join operation 1507 is performed, the cloud data platform or component thereof such as the aggregation system 250, compares the data values of the join columns between the tables and identifies matching rows according to the predicate (e.g., aggregation constraint policy). The matching rows from tables foo and bar are combined to form a result set.

A constrained GROUP-BY clause (e.g., a constrained aggregate) can be physically implemented according to building blocks (e.g., fundamental elements used to construct the UML diagram) illustrated to represent various aspects of the aggregation system being modeled in UML diagram 1500. The UML building blocks include, for example, a bottom block 1509, a regular block 1517, a residual block (e.g., crumbs) 1523, and a top block 1533. After the join operation 1507, the bottom block 1509 consists of a GROUP-BY operation 1511 that computes an intermediate (e.g., external) result for every aggregate function. The GROUP-BY operation 1511 (e.g., used with an aggregate) is a query block that either has a group by key or has an aggregate function (e.g., in either the SELECT clause or the HAVING clause). In addition, the bottom block 1509 computes a COUNT(1) operation 1513 and these calculations are split 1515 between the regular block 1517 and the residual block 1523.

The bottom block 1509 of the UML diagram 1500 is connected to the regular block 1517 through a split operation 1515 followed by a filter operation 1519 on the group size. The regular block 1517 consists of an optional projection operation 1521 that terminates the intermediate result into output formats. For example, the output results can include computing a Harmonic Linear Log-Log (HLLL) estimate employing a logarithmic transformation on data to create a linear relationship to allow for more accurate estimation of quantities. In another example, the output results could include a t-digest algorithm to estimate a probability distribution to summarize a large set of data points. In further examples, other techniques can be employed to estimate probability distributions and/or summary statistics from data.

The bottom block 1509 is similarly connected through the split operation 1515 to the residual block 1523 through another filter operation 1525 on the group size. The residual block 1523 can include or consist of a pair (e.g., a child/parent pair) of scalar aggregate operators 1527 responsible for computing a regrouping operation 1531 for all groups that fall below a minimum group size threshold. In some examples, the output of the residual block 1523 is guarded with an additional filter operation 1529 on group size, where the output of the residual block 1523 can be dropped (e.g., ignored) if its total group size is still below the minimum group size after the regrouping operation 1531.

The top block 1533 includes the final results that are combined through a UNION ALL operator 1535.

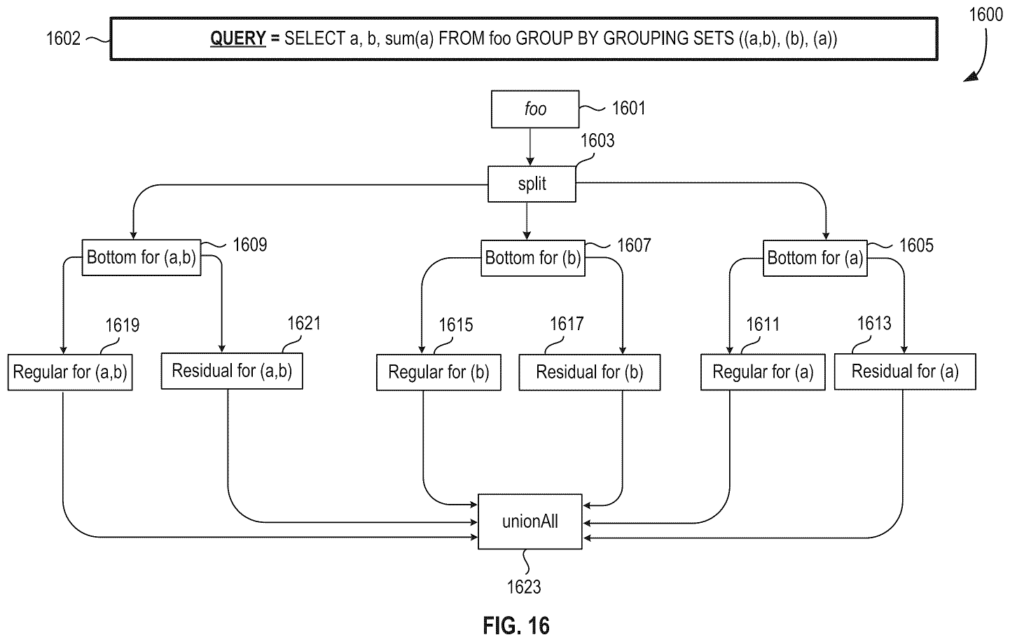

FIG. 16 includes a Unified Modeling Language (UML) diagram 1600 to represent different aspects of an implementation of a system of aggregation constraints, including examples for a query with nontrivial grouping sets, according to some example embodiments. The UML diagram 1600 provides multiple sets of the bottom block 1509, regular block 1517, and the residual block 1523 as described and depicted in connection with FIG. 15.

The UML diagram 1600 is an example of using the diamond-shaped building block for a query with nontrivial grouping sets. In some example embodiments, if a constrained aggregate contains more than one grouping set, the diamond is repeated for as many times as there are grouping sets. The UML diagram 1600 illustrates example building blocks for a query 1602 with nontrivial grouping sets. The building blocks providing a plan fragment (e.g., a query plan, a query tree) for the query 1602, where the aggregation operations can enhance the query plan by operating on values across rows to perform mathematical calculations (e.g., identifying minimum and maximum values, counting values in a dataset that are distinct, ranking values, computing standard deviations, and the like) and non-mathematical operation. For example, the aggregation operation can take one or more rows as input to produce a single row for each group according to the grouping key (e.g., set of identifiers or attributes for aggregating data). In other examples, such as scalar operations, the operations can take in one row as input and produce one row as output.

Turning to the query plan depicted in UML diagram 1600, it provides an example query plan that corresponds to the query 1602. For example, query 1602 requests SELECT a, b, sum(a) FROM foo GROUP BY GROUPING SETS ((a,b), (b), (a)), where foo 1601 is an aggregation-constrained table. In the example UML diagram 1600, the query plan shows the query 1602 is split 1603 and divided into three bottom blocks 1605/1607/1609, which are further divided based on minimum group size into regular blocks 1611/1615/1619 and residual blocks 1613/1617/1621.

The final results are then combined through a UNION ALL operator 1623, where the output of the residuals can be guarded with another filter on the group size, and the residuals (e.g., crumbs) output can be dropped if its group size is still below the minimum after regrouping.

FIGS. 17-19 illustrate various flow diagrams of various example methods 1700-1900 for implementing aggregation constraints, according to some example embodiments. According to the example embodiments of FIGS. 17-19, different example embodiments disclose methods of the aggregation system 250. For example, the methods 1700-1900 can be embodied in machine-readable instructions for execution by one or more hardware components (e.g., one or more processors) such that the operations of the methods 1700-1900 can be performed by components of the cloud data platform 102. Accordingly, the methods 1700-1900 are described below, by way of example with reference to components of the cloud data platform 102. However, it shall be appreciated that methods 1700-1900 can be deployed on various other hardware configurations and is not intended to be limited to deployment within the cloud data platform 102. Depending on the embodiment, an operation of the methods 1700-1900 can be repeated in different ways or involve intervening operations not shown. Though the operations of the methods 1700-1900 can be depicted and described in a certain order, the order in which the operations are performed may vary among embodiments, including performing certain operations in parallel or performing sets of operations in separate processes. While the various operations in these flowcharts 1700-1900 are presented and described sequentially, one of ordinary skill will appreciate that some or all of the operations may be executed in a different order, be combined or omitted, or be executed in parallel.

FIG. 17 shows an example flow diagram of a method 1700 for performing a uniqueness check in an aggregation constraint system, according to some example embodiments.

Operation 1702 is for receiving, by the aggregation system 250, a query directed toward a shared dataset. From operation 1702, the method 1700 flows to operation 1704 for determining, by the aggregation system 250, a table of the shared dataset to perform operations of the query. From operation 1704, the method 1700 flows to operation 1706 for determining, by the aggregation system 250, whether an aggregation constraint is attached to the tables. From operation 1706, the method 1700 flows to operation 1708 for applying, by the aggregation system 250, a uniqueness check. From operation 1708, the method 1700 flows to operation 1710 for enforcing, by the aggregation system 250, the aggregation constraint in relation to the query.

For example, a uniqueness check is performed on opposite sides on any aggregation-constrained relation. In additional examples, for each aggregation-constrained table, a uniqueness check is performed to check the uniqueness of that table joined against each other table. In additional examples, a uniqueness check is performed according to an order the JOINS appeared in the query. In additional examples, join-key uniqueness on both sides of every JOIN operation is required (e.g., column a is unique of foo, column c is unique over bar, column d is unique over bar, etc.). After all operations (e.g., joins/filters) are completed, the system checks whether any rows from a constrained table are still unique. If not, then the system has caught a join operation that amplifies the constrained table and emits a user error instead of output.

For example, an aggregation constraint system, such the aggregation system 250, can include building blocks and one or more unique checks can be performed. For example, the group-by operation can be co-opted with a custom (e.g., bespoke) aggregate function UNIQ_ANY_VALUE(ANY) (a modified ANY_VALUE(ANY)): (1) The accumulate function would error out, (2) The combine function would error out, probably can by default reuse the same code of accumulate, (3) The rest of the functions are identical to ANY_VALUE(ANY), and (4) the API can be extended as UNIQ_ANY_VALUE(ANY, ErrId, ErrMsg) so that the error message can be easily derived from ErrId/ErrMsg, most for code extensibility. Now, the unique check operator can be implemented by using a Hash Aggregate operator (or a pair of operators): (1) the group keys of the unique check operator will become the group keys of the aggregate row set operator (RSO) that can be performed by the execution platform 110 on database rows (e.g., like a filter), or (2) for each input column x that is not a group key, it is wrapped in the aforementioned UNIQ_ANY_VALUE(x) aggregate function.

For example, FIG. 17 depicts the use of a GROUP-BY operation that is generated for checking uniqueness after a join operation in which aggregation constraints can be implemented, in accordance with some example embodiments. The aggregation constrained GROUP-BY operation is a constrained GROUP-BY physically implemented and consisting of a GROUP-BY operator that computes the intermediate (e.g., “external”) result for every aggregate function. In addition, it consists of an aggregation (and/or optional projection) that terminates the intermediate result into output formats (e.g., computing the HLLL_ESTIMATE or t-digest estimate on the sketch output from the bottom).

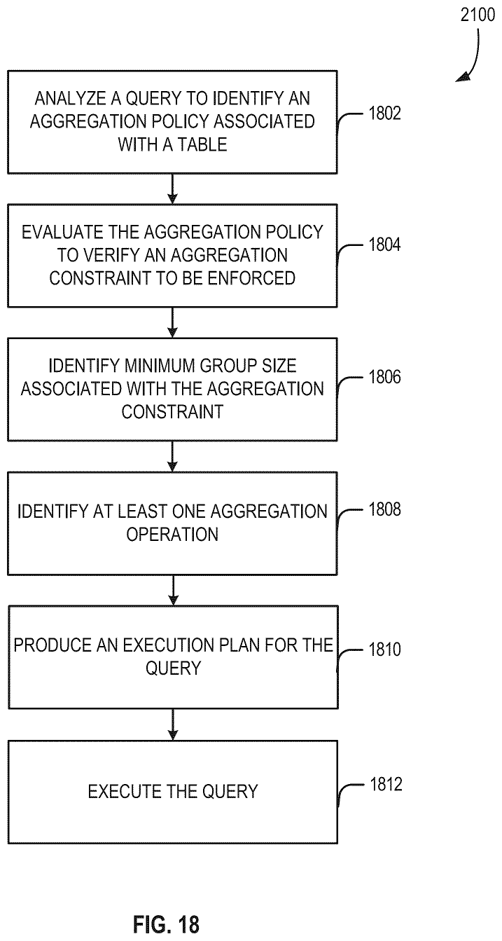

FIG. 18 shows an example flow diagram of a method 1800 for executing a DISTINCT-qualified aggregate function in a constrained aggregation query block, according to some example embodiments.

Operation 1802 is for analyzing, by the aggregation system 250, a query to identify an aggregation policy associated with one or more tables identified in the query. From operation 1802, the method 1800 flows to operation 1804 for evaluating, by the aggregation system 250, the aggregation policy to verify an aggregation constraint to be enforced. From operation 1804, the method 1800 flows to operation 1806 for identifying, by the aggregation system 250, a minimum group size associated with the aggregation constraint. From operation 1806, the method 1800 flows to operation 1808 for identifying, by the aggregation system 250, at least one aggregation operation. From operation 1808, the method 1800 flows to operation 1810 for producing, by the aggregation system 250, an execution plan for the query. From operation 1810, the method 1800 flows to operation 1812 for executing, by the aggregation system 250, the query.

For example, the method 1800 illustrates an example for implementing a plan fragment, such as the plan fragments described and depicted in connection with FIGS. 14 and 16, for the query: SELECT b, SUM(DISTINCT a) FROM foo GROUP BY b, with a minimum group size of 100. For example, at least one aggregation operation can include a DISTINCT-qualified aggregate function, which can be mixed with other aggregate functions and computed in branches before stitching. For example, the cloud data platform can include an SQL compiler to analyze the query to check whether any tables or views being accessed have an aggregation policy. If so, the system evaluates the policy to determine if an aggregation constraint should be enforced, and if so, with what minimum group size. For example, the compiler analyzes a query parse tree to ensure that the rules are followed (e.g., the path in the tree from aggregation-constrained data access to the root of the tree contains at least one aggregation operation (e.g., GROUP-BY operation). In some examples, the cloud data platform produces an execution plan for the query and actually executes the query to perform additional actions. For example, such actions can ensure that the minimum group size is appropriately enforced by tracking and counting the number of rows of each aggregation-constrained table that is represented in each group. In other examples, the analysis can occur in a data flow graph rather than a parse tree.

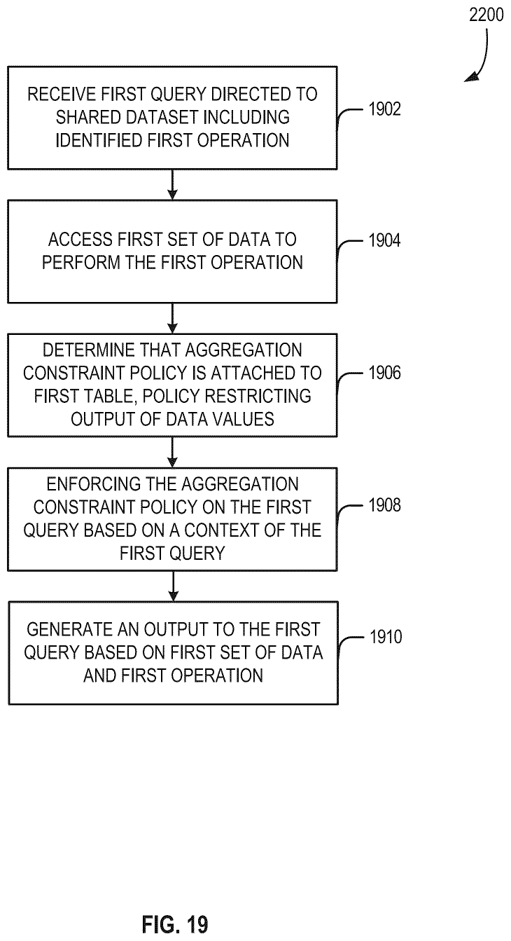

FIG. 19 illustrates an example flow diagram of a method 1900 using an aggregation constraint system for a query with nontrivial grouping sets, according to some example embodiments. The method 1900 is an example of using the diamond-shaped building block for a query with nontrivial grouping sets. In some example embodiments, if a constrained aggregate contains more than one grouping set, the diamond is repeated for as many times as there are grouping sets.

Operation 1902 is for receiving, by the aggregation system 250, a first query directed towards a shared dataset, the first query identifying a first operation. From operation 1902, the method 1900 flows to operation 1904 for accessing, by the aggregation system 250, a first set of data from the shared dataset to perform the first operation, the first set of data including data accessed from a first table of the shared dataset. From operation 1904, the method 1900 flows to operation 1906 for determining, by the aggregation system 250, that an aggregation constraint policy is attached to the first table, the aggregation constraint policy restricting output of data values stored in the first table. From operation 1906, the method 1900 flows to operation 1908 for enforcing, by the aggregation system 250, the aggregation constraint policy on the first query based on a context of the first query. From operation 1908, the method 1900 flows to operation 1910 for generating, by the aggregation system 250, an output to the first query based on the first set of data and the first operation, the output to the first query not including data values stored in the first table based on determining that the aggregation constraint policy should be enforced in relation to the first query.

For example, a combine agg (e.g., “combine” aggregate) is one of two aggregate modes that takes inputs in external format (e.g., a parent aggregate), produces outputs in external format (e.g., a child aggregate), and/or pass-through in COMBINE_PARENT mode (e.g., waits until all inputs are consumed, spills to disk if necessary (e.g., like a parent aggregate) or in COMBINE_CHILD mode (e.g., choose to flush to downstream link if under memory pressure or high cardinality). In some example embodiments, some aggregates can have an explicit “combine” version. For example, in the absence of the two proposed “combine” aggregate modes, a query such as SELECT COUNT(a) FROM foo GROUP BY b, where foo is an aggregation-constrained table, can be implemented according to the method 1900 or other similar example embodiments.

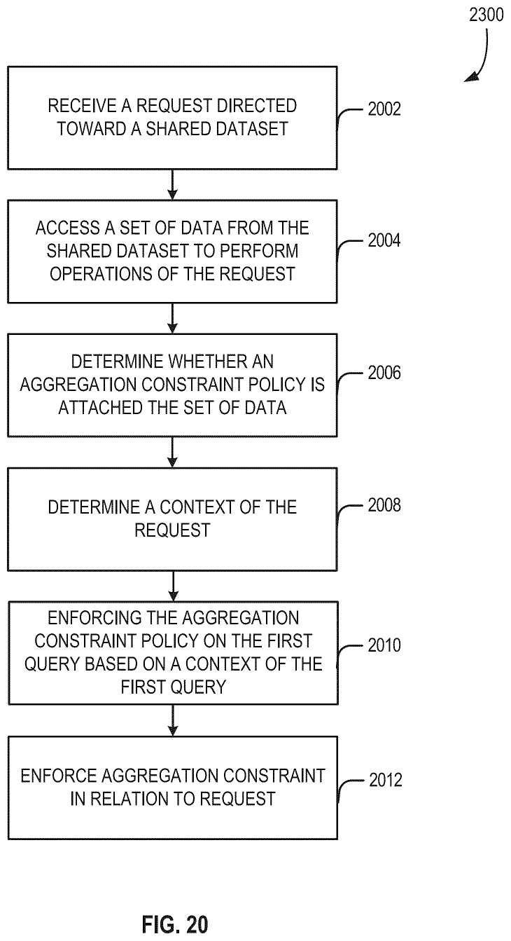

FIG. 20 illustrates an example flow diagram of a method 2000 for implementing aggregation constraint-based access to a shared dataset in a cloud data platform, according to some example embodiments. The method 2000 can be embodied in machine-readable instructions for execution by one or more hardware components (e.g., one or more processors, one or more hardware processors) such that the operation of the method 2000 can be performed by components of the system depicted in FIG. 1, such as the cloud data platform 102, or the aggregation system 250 described and depicted in connection with FIGS. 2 and 3. Accordingly, the method 2000 is described below, by way of example with reference to components of the aggregation system 250. However, it shall be appreciated that method 2000 can be deployed on various other hardware configurations and is not intended to be limited to deployment within the hardware of examples presented herein. Depending on the example embodiment, an operation of the method 2000 can be repeated in different ways or involve intervening operations not shown. Though the operations of the method 2000 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined or omitted, or be executed in parallel.

Operation 2002 is for receiving, by the aggregation system 250, a request directed toward a shared dataset. From operation 2002, the method 2000 flows to operation 2004 for accessing, by the aggregation system 250, a set of data from the shared dataset to perform operations of the request. From operation 2004, the method 2000 flows to operation 2004 for determining, by the aggregation system 250, whether an aggregation constraint policy is attached to the set of data. From operation 2006, the method 2000 flows to operation 2008 for determining, by the aggregation system 250, a context of the request.

From operation 2008, the method 2000 flows to operation 2010 for enforcing, by the aggregation system 250, the aggregation constraint policy on the first query based on a context of the first query (e.g., determining whether an aggregation constraint should be enforced in relation to the received request). From operation 2010, the method 2000 flows to operation 2012 for enforcing, by the aggregation system 250, the aggregation constraint in relation to the received request.

For example, a name-resolved parse tree (e.g., syntax tree) of a query to ensure its compliance with all aggregation constraints and identifying all the query blocks that aggregate aggregation-constrained tables. For example, during query block translation, a constrained aggregation query block is translated into a query plan node (e.g., QueryPlanNodeConstrainedGroupBy) that (a) represents the constrained group-by (which produces the crumbs group), (b) represent the runtime uniqueness check, and (c) if there is no join below the constrained GroupBy, the uniqueness check is omitted. For example, a plan rewrite expands the logical constrained group-by into a diamond-shaped construct of physical nodes.

According to some example embodiments, semantic enforcement is performed for recognizing constrained Group-By operations. For example, if there is a query SELECT SUM(a) FROM foo GROUP BY b, then the sole query block is the constrained GROUP-BY for constrained table foo. In additional example embodiments, a bottom-up pass on the parse tree is implemented to determine whether each query block contains constrained tables/views that are unaggregated: A query block G that is a GROUP-BY (including scalar GROUP-BY) is considered to never contain unaggregated constrained tables. If any object in the FROM clause of a GROUP-BY query block G contains unaggregated constrained tables, G is marked as a constrained GROUP-BY. Otherwise, if any object in the FROM clause of a non-GROUP-BY query block Q contains unaggregated constrained tables, Q is considered to contain unaggregated constrained tables.

In additional examples, a policy violation (e.g., violation of an aggregation constraint policy) can be reported to the cloud data platform 102 and/or to the provider when a request (e.g., a query) violates an aggregation constraint. For example, a policy violation is reported if the top selecting query block contains unaggregated constrained tables, if the query block of a scalar subquery contains unaggregated constrained tables, or in other scenarios that violate an aggregation constraint.

In additional examples, a compliant query can associate a constrained GROUP-BY with each object reference to an aggregation-constrained table. After the traversal, any object reference to a constrained table or view foo that does not have an associated constrained GROUP-BY (e.g., by being unaggregated in a subquery in the WHERE clause or the SELECT clause) causes violation of aggregation policies. For example, according to one example embodiment of the aggregation system, the following queries would violate the requirement to aggregate a constrained table foo: SELECT SUM(d), EXISTS (SELECT a FROM foo WHERE a=bar.c) FROM bar GROUP BY c and SELECT d FROM bar WHERE d>ANY (SELECT c FROM foo) GROUP BY d. For the first query, foo is considered unaggregated; while the state diagram is traversed bottom up, a link through the FROM clause is followed. Similarly, foo is unaggregated in the second query.

In additional examples, enforcing pre-processing restrictions can be applied in the aggregation system 250. In a constrained aggregation, every compliant aggregate function (e.g., agg(x1, x2, . . . )) can either take constant arguments, column references, table references, or some scalar expression derived from a column reference or constant. Where a scalar expression is an expression that evaluates to a single scalar value, which refers to a single data element (e.g., a number, a string, a Boolean, etc.) as opposed to a complex data structure of a set of values. In one example, constant expressions can be allowed as arguments to some or all aggregation functions, such as: (a) 42, (b) ln(42), or (c) exp(42). In a second example, column references (e.g., all column references, not just references to columns of aggregation-constrained tables) can be allowed as arguments to permitted aggregation functions. For example, (a) AVG(c) and COUNT(c) are allowed, but (b) MAX(a) is not allowed if max(ANY) is not permitted. In a third example, there is a set of permitted expressions that can derive from column references (e.g., TRY_CAST).

To determine whether the argument expression x to an aggregation function invocation agg( ) is permitted, a post-order traversal is used with an additional context that the “current” GROUP-BY query block. For example, the current GROUP-BY is null initially. Then, before the children of a GROUP-BY query block (GQB) is traversed, the current GROUP-BY is set to GQB and reset the current GROUP-BY to its previous value when all the children of GQB are finished traversing.

In some example embodiments, the methods described and depicted in connection with FIGS. 17-20, as well as the above behaviors, can be implemented with a stack. For example, at each level of a different GROUP-BY query block, three colors (e.g., yellow for “clean” expressions such as constants, green for column references and permitted derivatives of columns, and blue for disallowed derivatives of column references) can be assigned to each scalar expression x. After traversing a child GROUP-BY query block, if any scalar expression y in the SELECT list of the child GROUP-BY query block is blue, there is a policy violation; otherwise, every scalar expression y is marked in the SELECT list of the child GROUP-BY query block as yellow in the current GQB.

Per the color indicators, if x is a constant, it is marked as yellow and if x is a column reference it is marked as green. If x is a function invocation f( . . . ), the system can determine if any of its arguments is marked blue, then x is marked as blue; otherwise, if any of its arguments is marked green and f is a permitted cleaning function (e.g., TRY_CAST), x is marked as green (otherwise, x is marked as blue). Otherwise, x is marked as yellow. Last, if x is an aggregate function invocation agg( . . . ), the system can determine if any of its arguments is marked blue, then the aggregate function invocation agg( . . . ) causes an aggregation policy violation. Alternatively, if any of its arguments is marked green but agg is not a permitted aggregate function, agg( . . . ) causes an aggregation policy violation. Otherwise, if agg is a permitted aggregation function (e.g., COUNT, SUM, and AVG), then agg( . . . ) is marked as yellow. Otherwise, agg( . . . ) is marked as yellow. In alternative example embodiments, other alpha-numerics or infographics can be used in place of colors.

In additional examples, the aggregation system can include plan generation. According to some example embodiments, once query blocks that are constrained aggregations are identified and the aggregation-constrained tables aggregated by each constrained GROUP-BY G, the effective minimum group size of G is determined (e.g., the maximum of “min group size” for all tables aggregated by G). Such a query block can be transformed into a query plan in three steps: (1) For pre-aggregation, generate a plan S for the pre-aggregation part of G (e.g., filter over join), (2) For uniqueness, for each aggregation-constrained table foo that is aggregated by G, insert a unique check building block Ufoo on top of S, and (3) For constrained-aggregation, after the chain of unique checks, generate the diamond shaped constrained-aggregation building block on top.

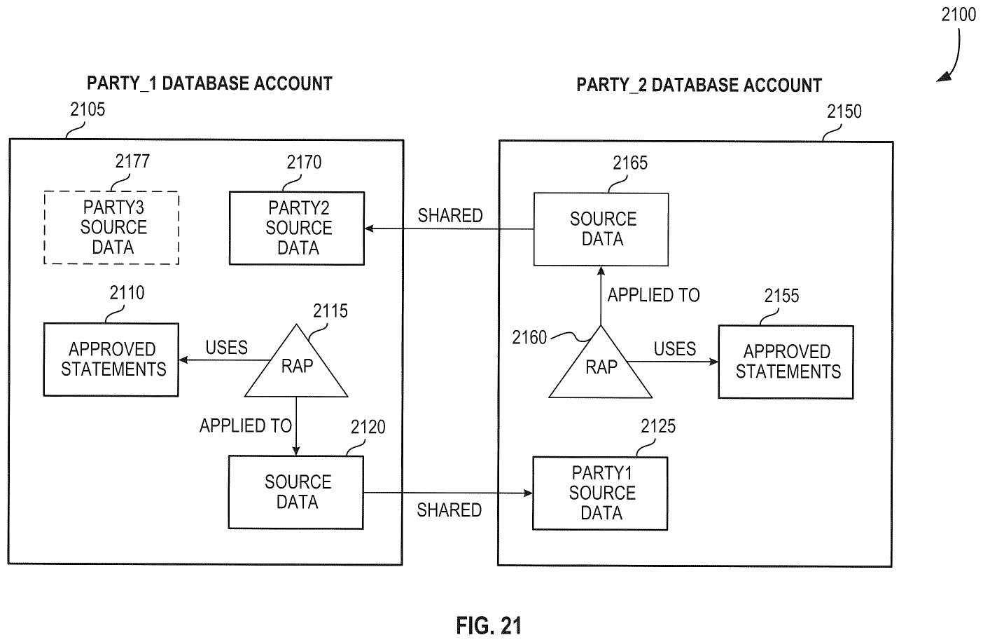

FIG. 21 shows an example block diagram 2100 of a dynamically restricted data clean room system 230, according to some example embodiments. In FIG. 21, a first database account 2105 and a second database account 2150 share data in a data clean room system 230 against which queries can be issued by either account. In the following example, the first database account 2105 provides data to the second database account 2150 (e.g., using approved statements table 2110, row access policy engine (RAP) 2115, source data 2120, and shared source data 2125), and it is appreciated that the second database account 2150 can similarly share data with the first database account 2105 (e.g., using approved statements table 2155, row access policy engine (RAP) 2160, source data 2165, and shared source data 2170).

In the example of FIG. 21, the data clean room system 230 implements a row access policy scheme (e.g., row access policy engine 2115, row access policy engine 2160) on the shared datasets of the first and second database accounts (e.g., source data 2120, source data 2165). In some example embodiments, the row access policy engine 2160 is implemented as a database object of the cloud data platform 102 that restricts source data of a database account for use and/or sharing in the clean room. In some example embodiments, a database object in the cloud data platform 102 is a data structure used to store and/or reference data. In some example embodiments, the cloud data platform 102 implements one or more of the following objects: a database table, a view, an index, a stored procedure of the cloud data platform, a user-defined function of the cloud data platform, or a sequence. In some example embodiments, when the cloud data platform 102 creates a database object type, the object is locked, and a new object type cannot be created due to the cloud data platform 102 restricting the object types using the source code of the cloud data platform. In some example embodiments, when objects are created, a database object instance is what is created by the cloud data platform 102 as an instance of a database object type (e.g., such as a new table, an index on that table, a view on the same table, application instance, or a new stored procedure object). The row access policy engine 2160 provides row-level security to data of the cloud data platform 102 through the use of row access policies to determine which rows to return in the query result. Examples of a row access policy include allowing one particular role to view rows of a table (e.g., user role of an end-user issuing the query), or including a mapping table in the policy definition to determine access to rows in a given query result. In some example embodiments, a row access policy is a schema-level object of the cloud data platform 102 that determines whether a given row in a table or view can be viewed from different types of database statements including SELECT statements or rows selected by UPDATE, DELETE, and MERGE statements.

In some example embodiments, the row access policies include conditions and functions to transform data at query runtime when those conditions are met. The policy data is implemented to limit sensitive data exposure. The policy data can further limit an object's owner (e.g., the role with the OWNERSHIP privilege on the object, such as a table or view) who normally has full access to the underlying data. In some example embodiments, a single row access policy engine is set on different tables and views to be implemented at the same time. In some example embodiments, a row access policy can be added to a table or view either when the object is created or after the object is created.

In some example embodiments, a row access policy comprises an expression that can specify database objects (e.g., table or view) and use conditional expression functions and context functions to determine which rows should be visible in a given context. The following is an example of a row access policy being implemented at query runtime: (A) for data specified in a query, the cloud data platform 102 determines whether a row access policy is set on a database object. If a policy is added to the database object, all rows are protected by the policy. (B) The distributed database system then creates a dynamic secure view (e.g., a secure database view) of the database object. (C) The policy expression is evaluated. For example, the policy expression can specify a “current statement” expression that only proceeds if the “current statement” is in the approved statements table or if the current role of the user that issued the query is a previously specified and allowed role. (D) Based on the evaluation of the policy, the restriction engine generates the query output, such as source data (e.g., provider source data) to be shared from a first database account to a second database account, where the query output only contains rows based on the policy definition evaluating to TRUE.

Continuing with reference to FIG. 21, the contents of the approved statements table is agreed upon or otherwise generated by the first database account 2105 and second database account 2150. For example, the users managing the first database account 2105 and second database account 2150 agree upon query language that is acceptable to both and include the query language in the approved statements table, and the agreed upon language is stored in the approved statements table 2110 on the first database account 2105 and also stored in the approved statements table 2155 in the second database account 2150. As an illustrative example, the source data 2120 of the first database account 2105 can include a first email dataset 2200 of the first database account's users, and the source data 2165 of the second database account 2150 can include a second email dataset 2250 of the second database accounts users, as illustrated in FIG. 22. The two database accounts may seek to determine how many of their user email addresses in their respective datasets match, where the returned result is a number (e.g., each has end users and the two database accounts are interested in how many users they share, but do not want to share the actual users' data). To this end, the two database accounts store “SELECT COUNT” in the approved query requests table. In this way, a counting query that selects and joins the source data can proceed, but a “SELECT *” query that requests and potentially returns all user data cannot proceed because it is not in the approved statements tables of the respective dataset accounts (e.g., the approved statements table 2110 and the approved statements table 2155).

Further, although only two database accounts are illustrated in FIG. 21, the data clean room system 230 enables two or more database accounts to share data through the clean room architecture. In past approaches, data clean room data is obfuscated (e.g., tokenized) and then shared in a data clean room, and the complexity of matching obfuscated data can result in limiting the data clean room data to only two parties at a time. In contrast, in the approach of FIG. 21, a third database account (not illustrated in FIG. 21) can provide a third-party shared dataset 2177 using the data clean room system 230 in the compute service manager 108, and database statements can be issued that join data from the three datasets, such as a SELECT COUNT on a joined data from the source data 2120, the shared source data 2170 from the second database account 2150, and the third-party shared dataset 2177 from the third database account (e.g., as opposed to a requester database account sharing data with a first provider database account, and the requester database account further correlating the data with another second provider database account using sequences of encrypted functions provided by the first and second provider accounts), in accordance with some example embodiments.

FIG. 22 shows example table data, according to some example embodiments. As an illustrative example, the source data 2120 of the first database account 2105 can include a first email dataset 2200 of the first database account's users, and the source data 2165 of the second database account 2150 can include a second email dataset 2250 of the second database accounts users, as illustrated in FIG. 22.

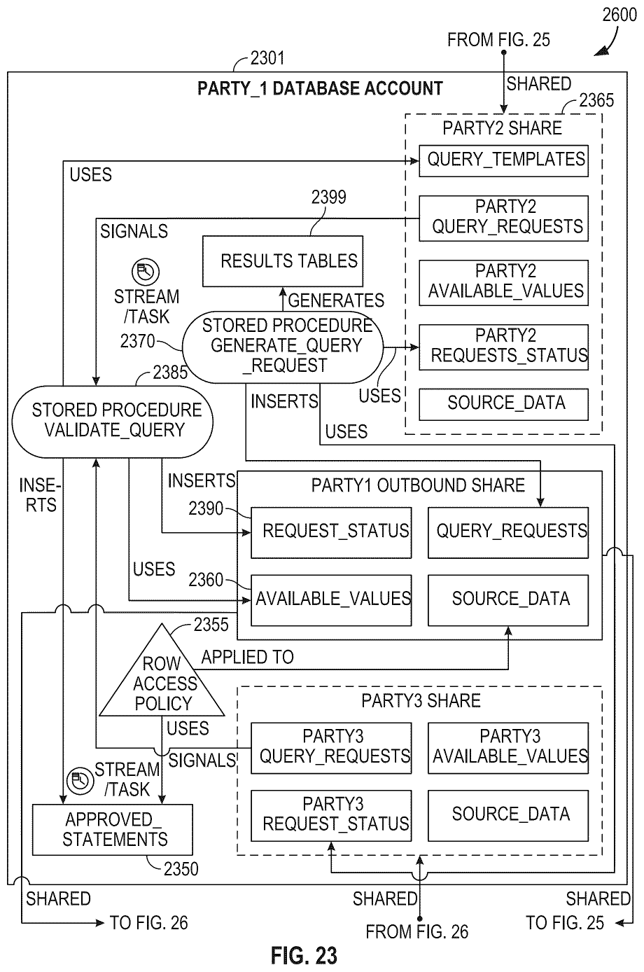

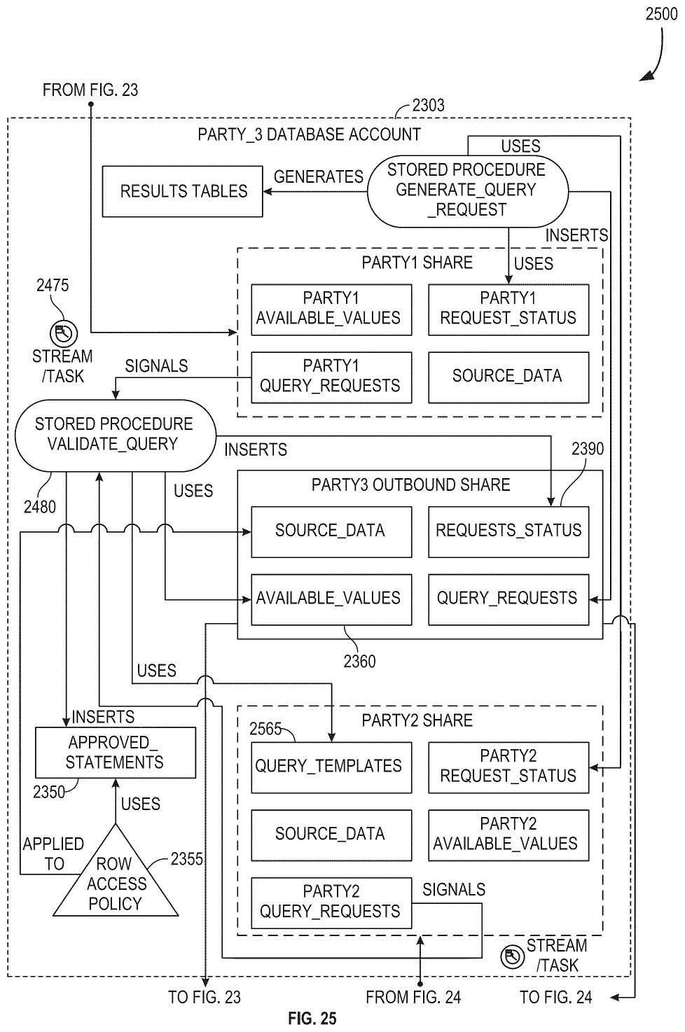

FIGS. 23-25 show examples of data clean room architecture for sharing data between multiple parties, according to some example embodiments. In the illustrated examples, party_1 database account 2301 is in FIG. 23, party_2 database account 2302 is in FIG. 24, and party_3 database account 2303 is in FIG. 25, where data is transferred (e.g., replicated, shared) between the different accounts, as indicated by the broken labeled arrows that refer to other figures. For example, in FIG. 25, a “Party2 Outbound Share” is shared from the party_2 database account 2302 to the party_1 database account 2301 in which the share is labeled as “Party2 Share” 2365 and connected by a broken arrow between FIG. 23 and FIG. 24. The below data flows refer to operations that each party performs to share data with the other parties of FIGS. 23-25. For example, at operation 2350, the party_1 database account 2301 creates its APPROVED_STATEMENTS in its own database instance (e.g., illustrated in FIG. 23); likewise at operation 2350, party_2 database account 2302 creates its APPROVED_STATEMENTS in its own database instance (e.g., illustrated in FIG. 24), and further, party_3 database account 2303 creates its APPROVED_STATEMENTS in its own database instance (e.g., illustrated in FIG. 25).

FIG. 23 shows an example of data clean room architecture 2300 for sharing data between multiple parties including party_1 database account 2301, according to some embodiments.

At operation 2350, each party creates an APPROVED_STATEMENTS table that will store the query request Structured Query Language (SQL) statements that have been validated and approved. In some example embodiments, one of the parties creates the approved statements table, which is then stored by the other parties. In some example embodiments, each of the parties creates their own approved statements table, and a given query on the shared data must satisfy each of the approved statements table or otherwise the query cannot proceed (e.g., “SELECT *” must be in each respective party's approved statements table in order for a query that contains “SELECT *” to operate on data shared between the parties of the cleanroom).

At operation 2355, each party creates a row access policy that will be applied to the source table(s) shared to each other party for clean room request processing. The row access policy will check the current_statement( ) function against values stored in the APPROVED_STATEMENTS table.

At operation 2360, each party will generate their AVAILABLE_VALUES table, which acts as a data dictionary for other parties to understand which tables, columns, and/or values they can use in query requests. In some example embodiments, the available values comprise schema, allowed columns, and metadata specifying prohibited rows or cell values. In some example embodiments, the available values data is not the actual data itself (e.g., source data) but rather specifies what data can be accessed (e.g., which columns of the source data) by the other parties (e.g., consumer accounts) for use in their respective shared data jobs (e.g., overlap analysis).

Continuing, at operation 2370 (FIG. 23), one of the parties (e.g., party_1 database account 2301, in this example) will generate a clean room query request by calling the GENERATE_QUERY_REQUEST stored procedure. This procedure will insert the new request into the QUERY_REQUESTS table. This table is shared to each other party, along with the source data table(s) that have the row access policy enabled, the party's AVAILABLE_VALUES table, and the REQUEST_STATUS table.

At operation 2385, the GENERATE_QUERY_REQUEST procedure will also call the VALIDATE_QUERY procedure on the requesting party's account. This is to ensure the query generated by each additional party and the requesting party matches, as an extra layer of validation.

At operation 2390, the REQUEST_STATUS table, which is shared by each party, is updated with the status from the VALIDATE_QUERY procedure. The GENERATE_QUERY_REQUEST procedure will wait and poll each REQUEST_STATUS table until a status is returned. At operation 2399, once each party has returned a status, the GENERATE_QUERY_REQUEST procedure will compare all of the CTAS statements (e.g., Create Table As Select operation in SQL) to ensure they match (if status is approved). If they all match, the procedure will execute the statement and generate the results table.

FIG. 24 shows an example of data clean room architecture 2400 for sharing data between multiple parties, including party_2 database account 2302, according to some example embodiments.

At operation 2475, each party has a stream object created against the other party's QUERY REQUESTS table, capturing any inserts to that table. A task object will run on a set schedule and execute the VALIDATE_QUERY stored procedure if the stream object has data. At operation 2480, the VALIDATE_QUERY procedure is configured to: (1) Ensure the query request select and filter columns are valid attributes by comparing against the AVAILABLE_VALUES table. (2) Ensure the query template accepts the variables submitted. (3) Ensure the threshold or other query restrictions are applied. (4) Generate a create table as select (CTAS) statement and store it in the APPROVED_STATEMENTS table if validation succeeds. (5) Update the REQUEST_STATUS table with success or failure. If successful, the create table as select (CTAS) statement is also added to the record.

FIG. 25 shows an example of data clean room architecture 2500 for sharing data between multiple parties, including party_3 database account 2303 where data is transferred (e.g., replicated, shared, etc.) between the different accounts, as indicated by the broken labeled arrows that refer to other figures, according to some example embodiments.

With reference to FIG. 25, at operation 2565, each party agrees on one or more query templates that can be used for query requests. For example, if a media publisher and advertiser are working together in a clean room, they may approve an “audience overlap” query template. The query template would store join information and other static logic, while using placeholders for the variables (select fields, filters, etc.). As an additional example, one of the parties is a provider account that specifies which statements are stored in the available statements table (e.g., thereby dictating how the provider's data will be accessed by any consumer account wanting to access the provider data). Further, in some example embodiments, the provider account further provides one or more query templates for use by any of the parties (e.g., consumer accounts) seeking to access the provider's data according to the query template. For example, a query template can comprise blanks or placeholders “{{______}}” that can be replaced by specific fields via the consumer request (e.g., the specific fields can be columns from the consumer data or columns from the provider data). Any change to the query template (e.g., adding an asterisk “*” to select all records) will be rejected by the data restrictions on the provider's data (e.g., the Row Access Policies (RAP) functions as a firewall for the provider's data).

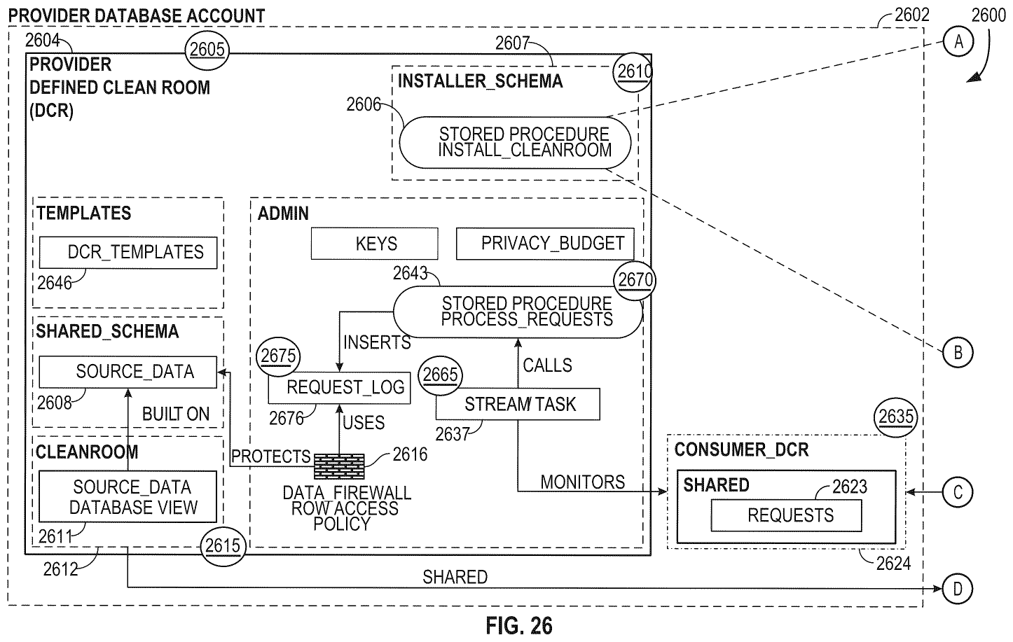

FIG. 26 shows an example data architecture 2600 for implementing defined access clean rooms using native applications, in accordance with some example embodiments.

In some example embodiments, a native application is configured so that a provider can create local state objects (e.g., tables, views, schema, etc.) and local compute objects (e.g., stored procedures, external functions, tasks, etc.) and also share objects representing the application logic in the consumer account. In some example embodiments, a native application is installed in the consumer accounts as a database instance that is shareable. For example, a provider can generate a native application that includes stored procedures and external functions that analyze and enrich data in a given consumer account. A consumer can install the provider's native application in the consumer's account as a database and call stored procedures in the installed native application that provide the application functionality. In some example embodiments, the native application is configured to write only to a database in the consumer account. Further, in some example embodiments, a native application of a provider can be packaged with one or more other objects such as tables, views, and stored procedures of the provider account, which are then generated in the consumer account upon installation via an installer script. In some example embodiments, the native application installer script is configured to: (1) create local objects in the consumer account, and (2) control the visibility of objects in native applications with the different consumer accounts that may install the provider's native application.

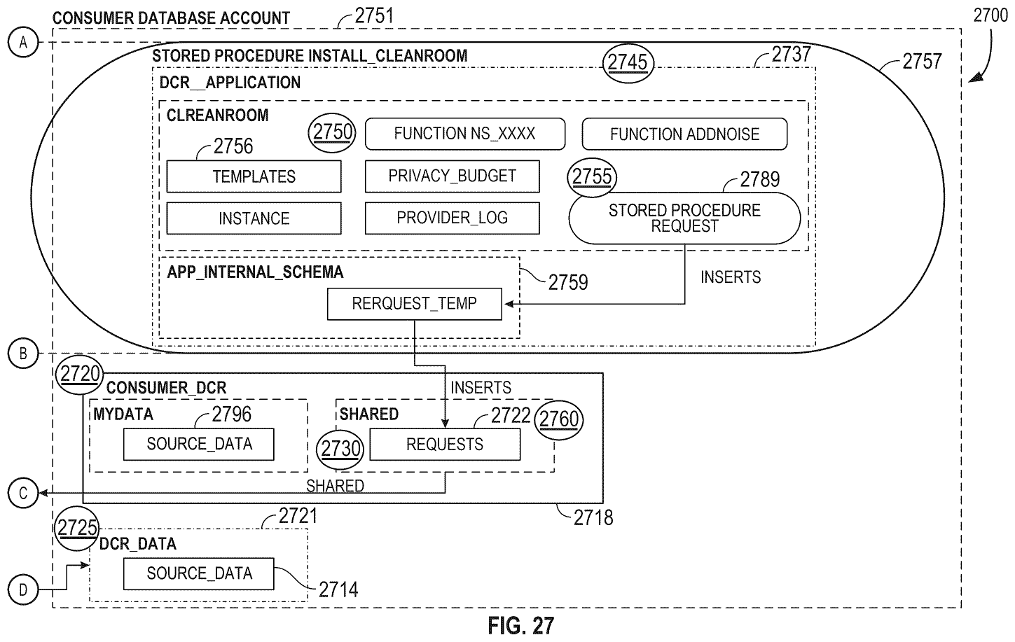

FIG. 26 shows a provider database account 2602 and FIG. 27 shows a consumer database account 2751 where connections between FIGS. 26 and 27 are shown using capital letters with circles (e.g., A, B, C, and D). With reference to FIG. 26, at operation 2605, the provider database account 2602 generates a defined access clean room 2604 (DCR). At operation 2610, the provider database account 2602 shares an installer 2607 clean room stored procedure 2606 as a native database application with the consumer database account 2751. At operation 2615 in FIG. 26, the provider database account 2602 shares source data 2608 as a source data database view 2611 in a clean room 2612, which is then accessible by the consumer database account 2751 as source data 2714 (in FIG. 27). While the source data 2714 is accessible as a share by the consumer database account 2751, the source data 2714 may be empty (e.g., not yet populated) and is controlled by a data firewall 2616, such as a row access policy of the provider database account 2602, as discussed above. In FIG. 27, at operation 2720, the consumer database account 2751 creates a clean room consumer database 2718 to store source data 2796.

At operation 2725, the consumer database account 2751 creates the database store 2721 to store the source data 2714 shared from the provider database account 2602. At operation 2730, the consumer database account 2751 shares a requests table 2722 with the provider database account 2602 as consumer-defined clean room shared requests table 2623 (in FIG. 26). At operation 2635, the provider database account 2602 creates a consumer store database 2624 to store a requests table 2623 received as a consumer share from the consumer database account 2751. Further, the provider database account 2602 creates a management object 2637 comprising a stream object to track changes on the requests table 2623, and a task object in the management object 2637 to execute the process requests stored procedure 2643 when a new request is input into the requests table 2623 (e.g., a request from the consumer and user that is input into the requests table 2722 and that is automatically shared as an entry in requests table 2623).

At operation 2760, consumer database account 2751 implements the request stored procedure 2789, which is configured to (1) generate a query based on the query template and the parameters passed in, (2) signed the query request using an encryption key created by the data clean room native application 2757 to authenticate to the provider database account 2602 that the data clean room native application 2757 issued the request, (3) apply differential privacy noise parameter to the query results based on an epsilon value (e.g., privacy budget) passed in with the query, and (4) when the query is input into the requests table 2722 the query is automatically shared with the provider as an entry in the requests table 2623.

At operation 2665 in FIG. 26, the provider database account 2602 implemented a stream to capture the insert entry into the requests table 2623 subsequently triggers the task of the management object 2637 to execute the process requests stored procedure 2643. At operation 2670, the process requests stored procedure 2643 executes the query that validates the requests. In some example embodiments, the validation that is performed by the process requests stored procedure 2643 comprises (1) determining that the encrypted request key matches the provider key, (2) confirming that the request originated from a corresponding preauthorized consumer account (e.g., consumer database account 2751), (3) confirming that the query uses a valid template from the templates 2646 (e.g., from a plurality of valid and preconfigured templates authorized by the provider), (4) confirming that the instant ID of data clean room native application 2757 matches the expected instance ID, and (5) confirming that the provider database account 2602 is the expected or preconfigured account. At operation 2675, if the request is valid, the provider database account 2602 updates the status as “approved” in a request log 2676, which configures the data firewall 2616 (e.g., row access policy) to provide access to one or more rows from the source data 2608; where the RAP provided rows are then shared to the consumer database account 2751 as source data 2714.

FIG. 27 shows an example data architecture 2700 for implementing defined access clean rooms using native applications, in accordance with some example embodiments.

At operation 2745, the consumer database account 2751 creates a database store 2721 to store the provider's shared source data 2714 (in FIG. 27), which initiates a stored procedure 2737 installer script that generates a runtime instance of a native application 2757. In FIG. 27, at operation 2750, the execution and creation of the data clean room native application 2757 using the native application installer procedure 2606 creates a clean room schema, and all of the objects within the clean room as specified in the native application installer procedure 2606, in accordance with some example embodiments. Further, the native application installer procedure 2606 grants privileges on the tables and the request data stored procedure. Further, the native application installer procedure 2606 creates application internal schema 2759 for use in request processing.

At operation 2755, the consumer database account 2751 generates a clean room request by calling the request stored procedure 2789 and passes in a query template name (e.g., of a template from query templates 2756, a template repository), selects groups by columns, filters, a privacy budget to implement, and any other parameters that are required for the query template chosen or otherwise passed in.

In FIG. 27, once the data is shared into the source data 2714, the consumer database account 2751 can execute the query within the data clean room native application 2757 on the consumer database account 2751 (e.g., by execution nodes of the consumer database account 2751).

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

Described implementations of the subject matter can include one or more features, alone or in combination as illustrated below by way of example.

Example 1 is a method comprising: receiving a first query directed towards a shared dataset, the first query identifying a first operation; accessing a first set of data from the shared dataset to perform the first operation, the first set of data including data accessed from a first table of the shared dataset; determining, by at least one hardware processor, that an aggregation constraint policy is attached to the first table, the aggregation constraint policy restricting output of data values stored in the first table; enforcing the aggregation constraint policy on the first query based on a context of the first query; and generating an output to the first query based on the first set of data and the first operation based on enforcing the aggregation constraint policy on the first query.

In Example 2, the subject matter of Example 1 includes, wherein the context of the first query is based on at least one of an account associated with the first query, a role of a user that submitted the first query, or data shares associated with the first query.

In Example 3, the subject matter of any one of Examples 1-2 optionally include, receiving data defining the aggregation constraint policy attached to the first table.

In Example 4, the subject matter of Example 3 includes, wherein the data defining the aggregation constraint policy comprises: specifying a principal that is subject to the aggregation constraint policy; and specifying, for the principal that is subject to the aggregation constraint policy, a minimum number of rows in the first table that must be aggregated in any valid query.

In Example 5, the subject matter of any one of Example 4 optionally include, determining whether the first query is a valid query based, at least in part, on the minimum number of rows in the first table; and rejecting the first query based on determining that the first query is invalid.

In Example 6, the subject matter of any one of Examples 1-5 optionally include, wherein the output to the first query based on the first set of data and the first operation comprises identifying a number of matching data values in the first table and a second table of the shared dataset.

In Example 7, the subject matter of any one of Examples 1-6 optionally include, receiving a second query directed towards the shared dataset, the second query identifying a second operation; accessing a second set of data from the shared dataset to perform the second operation, the second set of data including second data accessed from a second table of the shared dataset, the second table being different from the first table; determining that a second aggregation constraint policy is attached with the second table, the second aggregation constraint policy associated with the second table restricting aggregation of data values stored in the second table; enforcing the second aggregation constraint policy on the second query based on a context of the second query; and generating an output to the second query based on the second set of data and the second operation.

In Example 8, the subject matter of any one of Examples 1-7 optionally include, receiving a second query directed towards the shared dataset, the second query identifying a second operation; accessing a second set of data from the shared dataset to perform the second operation, the second set of data including the data accessed from the first table of the shared dataset; determining that the aggregation constraint policy is attached to the first table; opting not to enforce the aggregation constraint policy on the second query based on a context of the second query; and generating an output to the second query based on the second set of data and the second operation, the output to the second query including the data values stored in the first table based on the opting not to enforce the aggregation constraint policy on the second query based on the context of the second query.

In Example 9, the subject matter of any one of Examples 1-8 optionally include, wherein the shared dataset includes a first dataset associated with a first entity and a second dataset associated with a second entity, the first entity being associated with a first account of a cloud data platform that receives the first query, the first query being received from the second entity.

In Example 10, the subject matter of any one of Example 9 optionally include, generating a data clean room in the first account, the first account being associated with a provider database account; installing, in a second account, an application instance that implements the data clean room, the second account being associated with a consumer database account of the second entity; and sharing, by the provider database account, source provider data with the data clean room, the sharing making the source provider data accessible to the consumer database account via the application instance.

Example 11 is a system comprising: one or more hardware processors of a machine; and at least one memory storing instructions that, when executed by the one or more hardware processors, cause the system to perform operations comprising: receiving a first query directed towards a shared dataset, the first query identifying a first operation; accessing a first set of data from the shared dataset to perform the first operation, the first set of data including data accessed from a first table of the shared dataset; determining, by at least one hardware processor, that an aggregation constraint policy is attached to the first table, the aggregation constraint policy restricting output of data values stored in the first table; enforcing the aggregation constraint policy on the first query based on a context of the first query; and generating an output to the first query based on the first set of data and the first operation based on enforcing the aggregation constraint policy on the first query.

In Example 12, the subject matter of Example 11 includes, wherein the context of the first query is based on at least one of an account associated with the first query, a role of a user that submitted the first query, or data shares associated with the first query.

In Example 13, the subject matter of any one of Examples 11-12 optionally include, wherein the operations comprise receiving data defining the aggregation constraint policy attached to the first table.

In Example 14, the subject matter of Example 13 includes, wherein the data defining the aggregation constraint policy comprises: specifying a principal that is subject to the aggregation constraint policy; and specifying, for the principal that is subject to the aggregation constraint policy, a minimum number of rows in the first table that must be aggregated in any valid query.

In Example 15, the subject matter of Example 14 includes, wherein the operations comprise: determining whether the first query is a valid query based, at least in part, on the minimum number of rows in the first table; and rejecting the first query based on determining that the first query is invalid.

In Example 16, the subject matter of any one of Examples 11-15 optionally include, wherein the output to the first query based on the first set of data and the first operation comprises identifying a number of matching data values in the first table and a second table of the shared dataset.

In Example 17, the subject matter of any one of Examples 11-16 optionally include, wherein the operations comprise: receiving a second query directed towards the shared dataset, the second query identifying a second operation; accessing a second set of data from the shared dataset to perform the second operation, the second set of data including second data accessed from a second table of the shared dataset, the second table being different from the first table; determining that a second aggregation constraint policy is attached with the second table, the second aggregation constraint policy associated with the second table restricting aggregation of data values stored in the second table; enforcing the second aggregation constraint policy on the second query based on a context of the second query; and generating an output to the second query based on the second set of data and the second operation.

In Example 18, the subject matter of any one of Examples 11-17 optionally include, wherein the operations comprise: receiving a second query directed towards the shared dataset, the second query identifying a second operation; accessing a second set of data from the shared dataset to perform the second operation, the second set of data including the data accessed from the first table of the shared dataset; determining that the aggregation constraint policy is attached to the first table; opting not to enforce the aggregation constraint policy on the second query based on a context of the second query; and generating an output to the second query based on the second set of data and the second operation, the output to the second query including the data values stored in the first table based on the opting not to enforce the aggregation constraint policy on the second query based on the context of the second query.

In Example 19, the subject matter of any one of Examples 11-18 optionally include, wherein the shared dataset includes a first dataset associated with a first entity and a second dataset associated with a second entity, the first entity being associated with a first account of a cloud data platform that receives the first query, the first query being received from the second entity.

In Example 20, the subject matter of Example 19 includes, wherein the operations comprise: generating a data clean room in the first account, the first account being associated with a provider database account; installing, in a second account, an application instance that implements the data clean room, the second account being associated with a consumer database account of the second entity; and sharing, by the provider database account, source provider data with the data clean room, the sharing making the source provider data accessible to the consumer database account via the application instance.

Example 21 is a machine-storage medium embodying instructions that, when executed by a machine, cause the machine to perform operations comprising: receiving a first query directed towards a shared dataset, the first query identifying a first operation; accessing a first set of data from the shared dataset to perform the first operation, the first set of data including data accessed from a first table of the shared dataset; determining, by at least one hardware processor, that an aggregation constraint policy is attached to the first table, the aggregation constraint policy restricting output of data values stored in the first table; enforcing the aggregation constraint policy on the first query based on a context of the first query; and generating an output to the first query based on the first set of data and the first operation based on enforcing the aggregation constraint policy on the first query.

In Example 22, the subject matter of Example 21 includes, wherein the context of the first query is based on at least one of an account associated with the first query, a role of a user that submitted the first query, or data shares associated with the first query.

In Example 23, the subject matter of any one of Examples 21-22 optionally include, wherein the operations comprise receiving data defining the aggregation constraint policy attached to the first table.

In Example 24, the subject matter of Example 23 includes, wherein the data defining the aggregation constraint policy comprises: specifying a principal that is subject to the aggregation constraint policy; and specifying, for the principal that is subject to the aggregation constraint policy, a minimum number of rows in the first table that must be aggregated in any valid query.

In Example 25, the subject matter of Example 24 includes, wherein the operations comprise: determining whether the first query is a valid query based, at least in part, on the minimum number of rows in the first table; and rejecting the first query based on determining that the first query is invalid.

In Example 26, the subject matter of any one of Examples 21-25 optionally include, wherein the output to the first query based on the first set of data and the first operation comprises identifying a number of matching data values in the first table and a second table of the shared dataset.

In Example 27, the subject matter of any one of Examples 21-26 optionally include, wherein the operations comprise: receiving a second query directed towards the shared dataset, the second query identifying a second operation; accessing a second set of data from the shared dataset to perform the second operation, the second set of data including second data accessed from a second table of the shared dataset, the second table being different from the first table; determining that a second aggregation constraint policy is attached with the second table, the second aggregation constraint policy associated with the second table restricting aggregation of data values stored in the second table; enforcing the second aggregation constraint policy on the second query based on a context of the second query; and generating an output to the second query based on the second set of data and the second operation.

In Example 28, the subject matter of any one of Examples 21-27 optionally include, wherein the operations comprise: receiving a second query directed towards the shared dataset, the second query identifying a second operation; accessing a second set of data from the shared dataset to perform the second operation, the second set of data including the data accessed from the first table of the shared dataset; determining that the aggregation constraint policy is attached to the first table; opting not to enforce the aggregation constraint policy on the second query based on a context of the second query; and generating an output to the second query based on the second set of data and the second operation, the output to the second query including the data values stored in the first table based on the opting not to enforce the aggregation constraint policy on the second query based on the context of the second query.

In Example 29, the subject matter of any one of Examples 21-28 optionally include, wherein the shared dataset includes a first dataset associated with a first entity and a second dataset associated with a second entity, the first entity being associated with a first account of a cloud data platform that receives the first query, the first query being received from the second entity.

In Example 30, the subject matter of Example 29 includes, wherein the operations comprise: generating a data clean room in the first account, the first account being associated with a provider database account; installing, in a second account, an application instance that implements the data clean room, the second account being associated with a consumer database account of the second entity; and sharing, by the provider database account, source provider data with the data clean room, the sharing making the source provider data accessible to the consumer database account via the application instance.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

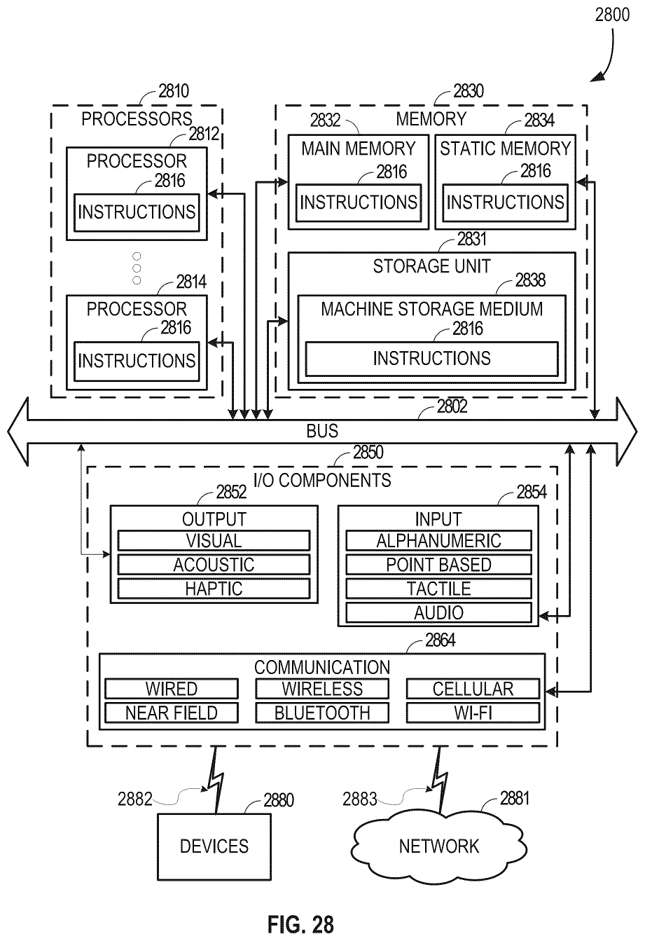

FIG. 28 illustrates a diagrammatic representation of a machine 2800 in the form of a computer system within which a set of instructions may be executed for causing the machine 2800 to perform any one or more of the methodologies discussed herein, according to an example embodiment. Specifically, FIG. 28 shows a diagrammatic representation of the machine 2800 in the example form of a computer system, within which instructions 2816 (e.g., software, a program, an application, an applet, an app, or other executable code), for causing the machine 2800 to perform any one or more of the methodologies discussed herein, may be executed. For example, the instructions 2816 may cause the machine 2800 to implement portions of the data flows described herein (e.g., data flows described and depicted in FIGS. 17-20). In this way, the instructions 2816 transform a general, non-programmed machine into a particular machine 2800 (e.g., the client device 114 of FIG. 1, the compute service manager 108 of FIG. 1, the execution platform 110 of FIG. 1) that is specially configured to carry out any one of the described and illustrated functions in the manner described herein.

In alternative embodiments, the machine 2800 operates as a standalone device or may be coupled (e.g., networked) to other machines. In a networked deployment, the machine 2800 may operate in the capacity of a server machine or a client machine in a server-client network environment, or as a peer machine in a peer-to-peer (or distributed) network environment. The machine 2800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 2816, sequentially or otherwise, that specify actions to be taken by the machine 2800. Further, while only a single machine 2800 is illustrated, the term “machine” shall also be taken to include a collection of machines 2800 that individually or jointly execute the instructions 2816 to perform any one or more of the methodologies discussed herein.

The machine 2800 includes processors 2810, memory 2830, and input/output (I/O) components 2850 configured to communicate with each other such as via a bus 2802. In an example embodiment, the processors 2810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2812 and a processor 2814 that may execute the instructions 2816. The term “processor” is intended to include multi-core processors 2810 that may comprise two or more independent processors (sometimes referred to as “cores”) that may execute instructions 2816 contemporaneously. Although FIG. 28 shows multiple processors 2810, the machine 2800 may include a single processor with a single core, a single processor with multiple cores (e.g., a multi-core processor), multiple processors with a single core, multiple processors with multiple cores, or any combination thereof.

The memory 2830 may include a main memory 2832, a static memory 2834, and a storage unit 2831, all accessible to the processors 2810 such as via the bus 2802. The main memory 2832, the static memory 2834, and the storage unit 2831 comprise a machine storage medium 2838 that may store the instructions 2816 embodying any one or more of the methodologies or functions described herein. The instructions 2816 may also reside, completely or partially, within the main memory 2832, within the static memory 2834, within the storage unit 2831, within at least one of the processors 2810 (e.g., within the processor's cache memory), or any suitable combination thereof, during execution thereof by the machine 2800.

The I/O components 2850 include components to receive input, provide output, produce output, transmit information, exchange information, capture measurements, and so on. The specific I/O components 2850 that are included in a particular machine 2800 will depend on the type of machine. For example, portable machines, such as mobile phones, will likely include a touch input device or other such input mechanisms, while a headless server machine will likely not include such a touch input device. It will be appreciated that the I/O components 2850 may include many other components that are not shown in FIG. 28. The I/O components 2850 are grouped according to functionality merely for simplifying the following discussion and the grouping is in no way limiting. In various example embodiments, the I/O components 2850 may include output components 2852 and input components 2854. The output components 2852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 2854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 2850 may include communication components 2864 operable to couple the machine 2800 to a network 2881 via a coupler 2883 or to devices 2880 via a coupling 2882. For example, the communication components 2864 may include a network interface component or another suitable device to interface with the network 2881. In further examples, the communication components 2864 may include wired communication components, wireless communication components, cellular communication components, and other communication components to provide communication via other modalities. The devices 2880 may be another machine or any of a wide variety of peripheral devices (e.g., a peripheral device coupled via a universal serial bus (USB)). For example, as noted above, the machine 2800 may correspond to any one of the client device 114, the compute service manager 108, and the execution platform 110, and may include any other of these systems and devices.

The various memories (e.g., 2830, 2832, 2834, and/or memory of the processor(s) 2810 and/or the storage unit 2831) may store one or more sets of instructions 2816 and data structures (e.g., software), embodying or utilized by any one or more of the methodologies or functions described herein. These instructions 2816, when executed by the processor(s) 2810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2881 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 2881 or a portion of the network 2881 may include a wireless or cellular network, and the coupling 2882 may be a Code Division Multiple Access (CDMA) connection, a Global System for Mobile communications (GSM) connection, or another type of cellular or wireless coupling. In this example, the coupling 2882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2816 may be transmitted or received over the network 2881 using a transmission medium via a network interface device (e.g., a network interface component included in the communication components 2864) and utilizing any one of a number of well-known transfer protocols (e.g., hypertext transfer protocol (HTTP)). Similarly, the instructions 2816 may be transmitted or received using a transmission medium via the coupling 2882 (e.g., a peer-to-peer coupling) to the devices 2880. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2816 for execution by the machine 2800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system comprising:
one or more hardware processors of a machine; and
at least one memory storing instructions that, when executed by the one or more hardware processors, cause the system to perform operations comprising:
receiving a first query directed towards a shared dataset;
accessing a first set of data from the shared dataset, the first set of data comprising data from a first table of the shared dataset;
determining that an aggregation constraint policy is attached to the first table, the aggregation constraint policy restricting output of data values stored in the first table;
performing a uniqueness check on join keys for a join operation associated with the first table, the uniqueness check comprising a verification that at least one row from the first table is not amplified in a result of the join operation;
enforcing the aggregation constraint policy on the first query based on the verification; and
generating an output to the first query based on the first set of data.

2. The system of claim 1, wherein a context of the first query is based on at least one of an account associated with the first query, a role of a user that submitted the first query, or data shares associated with the first query.

3. The system of claim 1, the operations further comprising:
receiving data defining the aggregation constraint policy attached to the first table.

4. The system of claim 3, wherein data defining the aggregation constraint policy is associated with:
specifying a principal that is subject to the aggregation constraint policy; and
specifying, for the principal that is subject to the aggregation constraint policy, a minimum number of rows in the first table that must be aggregated in any valid query.

5. The system of claim 4, the operations further comprising:
determining whether the first query is a valid query based, at least in part, on the minimum number of rows in the first table, and rejecting the first query based on determining that the first query is invalid.

6. The system of claim 1, wherein the output to the first query comprises identifying a number of matching data values in the first table and a second table of the shared dataset.

7. The system of claim 1, the operations further comprising:
receiving a second query directed towards the shared dataset, the second query identifying a second operation;
accessing a second set of data from the shared dataset to perform the second operation, the second set of data comprising second data accessed from a second table of the shared dataset, the second table being different from the first table;
determining that a second aggregation constraint policy is attached with the second table, the second aggregation constraint policy associated with the second table restricting aggregation of data values stored in the second table; and
enforcing the second aggregation constraint policy on the second query, and generating an output to the second query based on the second set of data.

8. The system of claim 1, the operations further comprising:
receiving a second query directed towards the shared dataset, the second query identifying a second operation;
accessing a second set of data from the shared dataset to perform the second operation, the second set of data comprising the data accessed from the first table of the shared dataset, determining that the aggregation constraint policy is attached to the first table;
opting not to enforce the aggregation constraint policy on the second query based on a context of the second query; and
generating an output to the second query based on the second set of data, the output to the second query comprising the data values stored in the first table based on the opting not to enforce the aggregation constraint policy on the second query.

9. The system of claim 1, wherein the shared dataset comprises a first dataset associated with a first entity and a second dataset associated with a second entity, the first entity being associated with a first account of a cloud data platform that receives the first query, the first query being received from the second entity.

10. The system of claim 9, the operations further comprising:
generating a data clean room in the first account, the first account being associated with a provider database account;
installing, in a second account, an application instance that implements the data clean room, the second account being associated with a consumer database account of the second entity; and
sharing, by the provider database account, source provider data with the data clean room, the sharing making the source provider data accessible to the consumer database account via the application instance.

11. The system of claim 1, the operations further comprising:
generating an audit log of queries received and actions taken in response to enforcement of the aggregation constraint policy; and
limiting a rate at which queries are received from a user or account subject to the aggregation constraint policy.

12. The system of claim 1, the operations further comprising:
applying differential privacy noise to aggregate query results in accordance with a privacy budget parameter specified in the aggregation constraint policy.

13. The system of claim 3, wherein the data defining the aggregation constraint policy further comprises data specifying a set of conditions for triggering enforcement of the aggregation constraint policy, the conditions including at least one of user role, account identity, or query type.

14. The system of claim 2, wherein the context of the first query further comprises a temporal parameter, and the aggregation constraint policy is enforced based on the temporal parameter.

15. The system of claim 7, wherein the second aggregation constraint policy specifies a different minimum group size or permitted aggregate function class than the aggregation constraint policy attached to the first table.

16. The system of claim 1, the operations further comprising:
prior to aggregation, restricting pre-processing operations on the first set of data to allow at least one of: filtering, joining with unique keys, or a set of cleaning functions; and
prohibiting arbitrary transformations that amplify or reveal individual data values.

17. A method comprising:
receiving, by at least one hardware processor, a first query directed towards a shared dataset;
accessing a first set of data from the shared dataset, the first set of data comprising data from a first table of the shared dataset;
determining, by the at least one hardware processor, that an aggregation constraint policy is attached to the first table, the aggregation constraint policy restricting output of data values stored in the first table;
performing, by the at least one hardware processor, a uniqueness check on join keys for a join operation associated with the first table, the uniqueness check comprising a verification that at least one row from the first table is not amplified in a result of the join operation;
enforcing the aggregation constraint policy on the first query based on the verification; and
generating an output to the first query based on the first set of data.

18. The method of claim 17, wherein a context of the first query is based on at least one of an account associated with the first query, a role of a user that submitted the first query, or data shares associated with the first query, and wherein the method further comprises:
receiving data defining the aggregation constraint policy attached to the first table.

19. A machine-storage medium embodying instructions that, when executed by a machine, cause the machine to perform operations comprising:
receiving a first query directed towards a shared dataset;
accessing a first set of data from the shared dataset, the first set of data comprising data from a first table of the shared dataset;
determining that an aggregation constraint policy is attached to the first table, the aggregation constraint policy restricting output of data values stored in the first table;
performing a uniqueness check on join keys for a join operation associated with the first table, the uniqueness check comprising a verification that at least one row from the first table is not amplified in a result of the join operation;
enforcing the aggregation constraint policy on the first query based on the verification; and
generating an output to the first query based on the first set of data.

20. The machine-storage medium of claim 19, wherein a context of the first query is based on at least one of an account associated with the first query, a role of a user that submitted the first query, or data shares associated with the first query, and the operations further comprising:
receiving data defining the aggregation constraint policy attached to the first table, wherein data defining the aggregation constraint policy is associated with:
specifying a principal that is subject to the aggregation constraint policy; and
specifying, for the principal that is subject to the aggregation constraint policy, a minimum number of rows in the first table that must be aggregated in any valid query.
